(19) United States
(12) Patent Application Publication
(10) Pub. No.: US 2021/0281406 A1
(43) Pub. Date: Sep. 9, 2021

(54) CRYPTOGRAPHIC SECURITY SYSTEM, METHOD, AND PROGRAM PRODUCT USING DATA PARTITIONING

(71) Applicant: Timothy Arthur Huck, Richardson, TX (US)

(72) Inventor: Timothy Arthur Huck, Richardson, TX (US)

(21) Appl. No.: 16/810,717

(22) Filed: Mar. 5, 2020

(51) Int. Cl. H04L 9/14; G06F 21/60; H04L 9/06

(52) U.S. Cl. CPC H04L 9/14; H04L 9/065; G06F 21/602

(57) ABSTRACT

A method, system, and program product includes receiving data and retrieving a set of partitioning algorithms and distinct, cryptographic key and key-based cryptographic algorithm rule pairs. The data is partitioned using the set of partitioning algorithms to produce data partitions. An operation is performed on each of the data partitions using one of the distinct, cryptographic key and key-based cryptographic algorithm rule pairs to generate resulting partitions. The resulting partitions are then assembled to form encrypted data messages or raw data messages. A list of partitioning and cryptographic algorithms, identifiers, keys, offsets and data sources are used as a configuration to control encryption and decryption operations.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to a cryptographic security system using data partitioning and configurable key-based encryption and/or decryption. More particularly, certain embodiments of the invention permit for data from a file or stream to be broken into multiple parts or partitions where a different key and key-based algorithm is applied to each partition during encryption and/or decryption.

### BACKGROUND OF THE RELEVANT PRIOR ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Cryptography (also referred to as “cryptology”) refers to the practice and study of techniques for secure communication designed to avoid detection or comprehension by adversarial third parties. Cryptography constructs and analyzes rules and protocols that prevent or obstruct third parties or the unintended public from reading private messages. Modern cryptographic techniques exist at the intersection of communication and computer science and have been applied in electronic commerce, payment cards, digital currencies, computer passwords, and military communications, among other areas.

Within cryptography, key-based cryptography has emerged as the primary method for secure data storage, email, private messaging and network communications. There are currently two popular approaches using key-based encryption/decryption: (1) symmetric or “single-key” cryptography; and, (2) “public/private” or “dual-key” cryptography. Symmetric-key cryptography refers to encryption methods in which both the sender and receiver share the same key (or, less commonly, in which their keys are different, but related in an easily computable way). In contrast thereto, public-key cryptography, or asymmetric cryptography, is a key-based cryptographic system that uses pairs of keys: public keys which may be disseminated widely, and private keys which are known only to the owner. The generation of such keys depends on cryptographic algorithms based on mathematical problems to produce one-way functions. Effective security only requires keeping the private key private; the public key can be openly distributed without compromising security.

Security benefits offered by the implementation of advanced cryptographic techniques may be hampered due to current limitations and resulting difficulty of access even for a legitimate user, high general availability of the information sought to be protected via the cryptographic methods, challenges associated with selective access control, threats that emerge from the poor designs of systems, protocols and procedures, access to professional expertise and expense, as well as computational difficulties in implementing the cryptographic methods.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that data security systems exist that produce a steganographic selection key by using an encryption key as both the key and as the data to be encrypted. First an encryption key may be copied multiple times to form a data block which may be then encrypted using the same key. The resulting ciphertext may be then used as a selection key to select locations in a secondary data stream. These selected locations may be then modified with the original data to be encoded. Restoration of the original data may be accomplished by using the selection key to locate the modified areas of the data stream, extracting the data found there, and then decrypting the extracted data with the ciphertext.

By way of educational background, another aspect of the prior art generally useful to be aware of include efforts related to encoding and decoding information into a stream of digitized samples in an integral manner. The information may be encoded using special keys. The information may be contained in the samples, not prepended or appended to the sample stream. The method makes it extremely difficult to find the information in the samples if the proper keys are not possessed by the decoder. The method does not cause a significant degradation to the sample stream. The method may be used to establish ownership of copyrighted digital multimedia content and provide a disincentive to piracy of such material.

Also, methods are known for transforming a secrecy outcome of a one-dimensional one-time pad (“OTP”) beyond existing limitations to a multi-dimensioned encryption system, achieving modern-day perfect secrecy over unlimited distances by using cryptographic-steganographic key-container files for securing and hiding communications.

Known techniques have included a data security system that produces a steganographic selection key by using an encryption key as both the key and as the data to be encrypted. First an encryption key is copied multiple times to form a data block which is then encrypted using the same key. The resulting ciphertext is then used as a selection key to select locations in a secondary data stream. These selected locations are then modified with the original data to be encoded. Restoration of the original data is accomplished by using the selection key to locate the modified areas of the data stream, extracting the data found there, and then decrypting the extracted data with the ciphertext.

In view of the foregoing, it is clear that these traditional techniques may not be ideal for all situations and thus leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which: In general, throughout the document, references to Offset and Graph encoding as well as OTPs have been removed from HUCKTM01 as only HUCKTM02 deals with those. Those drawings were artifacts left over from the original submission before deciding to split the single patent into two patents.]

FIG. 1 illustrates an exemplary flow diagram of a modular and configurable single-pass, multi-partition, multi-key and multi-algorithm cryptographic system in accordance with an embodiment of the present invention;

FIG. 2 illustrates an exemplary partition handler during an encryption operation in accordance with an embodiment of the present invention;

FIG. 3 illustrates an exemplary partition handler during a decryption operation of the output of FIG. 4 in accordance with an embodiment of the present invention;

FIG. 4 illustrates an exemplary block diagram of a cryptography handler and multiple key-based cryptographic modules used for encryption of the output of FIG. 2 and reassembly of the encrypted partitions in accordance with an embodiment of the present invention;

FIG. 5 illustrates an exemplary block diagram of a cryptography handler and multiple key-based cryptographic modules used for decryption of the output of FIG. 3 in accordance with an embodiment of the present invention;

FIG. 6 illustrates an exemplary flow diagram of a method for applying a set of rules having multiple partitioning algorithms, cryptographic keys and key-based algorithms to encrypt and to decrypt data in discrete parts providing message secrecy, integrity and authenticity for communications and storage in accordance with an embodiment of the present invention;

FIG. 7 illustrates an exemplary block diagram denoting communication between a multi-algorithmic cryptographic service and a rule server associated therewith, both the multi-algorithmic cryptographic service and the rule server having multiple partitioning algorithms, cryptographic keys and key-based cryptographic algorithms to encrypt and to decrypt data in discrete parts providing message secrecy, integrity and authenticity for communications and storage in accordance with an embodiment of the present invention;

FIG. 8 illustrates an exemplary cryptographic module of a method for applying alphabetic character rotation—based cryptography in accordance with an embodiment of the present invention;

FIG. 9 illustrates exemplary data primitive operations for partitioning and assembly rules, the rules including various algorithms, keys, pads and media, the data primitive operations including sizing, shaping, shuffling, rotating, flipping, splitting, joining and reversing the data in accordance with an embodiment of the present invention;

FIG. 10 illustrates an exemplary block diagram depicting an example client/server system that may be used by an example web-enabled/networked embodiment of the present invention; and

FIG. 11 illustrates an exemplary block diagram depicting an example client/server communication system that may be used for a cryptographic security system using data partitioning and configurable key-based encryption and/or decryption in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially”. The ordinary meaning of “substantially halfway” is thus reasonably close to or nearly at the midpoint between the forwardmost point of the upper or outsole and the rearward most point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicant submits that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicant hereby gives notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

### Definitions

Reference to “Active Directory” implies a directory service that Microsoft (ID developed for the Windows® domain networks.

Reference to “algorithm” implies a set of instructions, typically solve a class of problems or perform a computation. Algorithms are unambiguous specifications for performing calculation, data processing, automated reasoning, and other tasks.

Reference to “authentication”, in cryptography, implies a message authentication code (MAC), sometimes known as a tag, is a short piece of information used to authenticate a message—in other words, to confirm that the message came from the stated sender (its authenticity) and has not been changed. The MAC value protects both a message's data integrity as well as its authenticity, by allowing verifiers (who also possess the secret key) to detect any changes to the message content.

Reference to “certificate”, in a cryptography context, implies a file which contains either a public key or public/private key pair.

Reference to “cipher” implies algorithm for performing encryption or decryption—a series of well-defined steps that can be followed as a procedure. An alternative, less common term is encipherment. To encipher or encode is to convert information into cipher or code. In common parlance, “cipher” is synonymous with “code”, as they are both a set of steps that encrypt a message; however, the concepts are distinct in cryptography, especially classical cryptography. Codes generally substitute different length strings of character in the output, while ciphers generally substitute the same number of characters as are input. There are exceptions and some cipher systems may use slightly more, or fewer, characters when output versus the number that were input. The operation of a cipher usually depends on a piece of auxiliary information, called a key (or “cryptovariable”). The encrypting procedure is varied depending on the key, which changes the detailed operation of the algorithm. A key must be selected before using a cipher to encrypt a message. Without knowledge of the key, it should be extremely difficult, if not impossible, to decrypt the resulting ciphertext into readable plaintext.

Reference to “cloud” implies the model of computer data storage in which the digital data is stored in logical pools. The physical storage spans multiple servers (sometimes in multiple locations), and the physical environment is typically owned and managed by a hosting company. These cloud storage providers are responsible for keeping the data available and accessible, and the physical environment protected and running. People and organizations buy or lease storage capacity from the providers to store user, organization, or application data. Cloud storage services may be accessed through a co-located cloud computing service, a web service application programming interface (API) or by applications that utilize the API, such as cloud desktop storage, a cloud storage gateway or Web-based content management systems.

Reference to “confidentiality” implies the concept of ensuring that data is not made available or disclosed to unauthorized people. Confidentially is achieved through encryption. Both symmetric and asymmetric encryption can be used. Confidentiality may have been the original purpose of cryptography. If the data is confidential, it cannot be read or understood by anyone other than the intended recipient or recipients. [Source: http://securitycerts.org/review/cryptography-confidentiality.htm; Retrieved on: Jun. 12, 2019].

Reference to “cryptography” or “cryptology” implies the practice and study of techniques for secure communication in the presence of third parties called adversaries. [Source: Rivest, Ronald L. (1990). “Cryptography”. In J. Van Leeuwen (ed.). Handbook of Theoretical Computer Science]. More generally, cryptography is about constructing and analyzing protocols that prevent third parties or the public from reading private messages; [source: Bellare, Mihir; Rogaway, Phillip (21 Sep. 2005). “Introduction”. Introduction to Modern Cryptography. p. 10.] various aspects in information security such as data confidentiality, data integrity, authentication, and non-repudiation [source: Menezes, A.J.; van Oorschot, P.C.; Vanstone, S.A. (1997). Handbook of Applied Cryptography. ISBN 978-0-8493-8523-0. Archived from the original on 7 Mar. 2005] are central to modern cryptography. Modern cryptography exists at the intersection of the disciplines of mathematics, computer science, electrical engineering, communication science, and physics. Applications of cryptography include electronic commerce, chip-based payment cards, digital currencies, computer passwords, and military communications. Modern cryptography is heavily based on mathematical theory and computer science practice; cryptographic algorithms are designed around computational hardness assumptions, making such algorithms hard to break in practice by any adversary.

Reference to “data” implies a set of values of subjects with respect to qualitative or quantitative variables. In a cryptography context, “data” implies a set of bytes, usually stored in volatile memory and obtained from storage, networks or other streams. Data has a starting byte and ending byte and the order of the bytes in between is integral to the information contained.

Reference to “data integrity” implies the maintenance of, and the assurance of the accuracy and consistency of, data over its entire life-cycle, [source: Boritz, J. “IS Practitioners’ Views on Core Concepts of Information Integrity”. International Journal of Accounting Information Systems. Elsevier. Archived from the original on 5 Oct. 2011. Retrieved 12 Aug. 2011] and is a critical aspect to the design, implementation and usage of any system which stores, processes, or retrieves data. The term is broad in scope and may have widely different meanings depending on the specific context—even under the same general umbrella of computing. It is at times used as a proxy term for data quality, [source: https://www.veracode.com/blog/2012/05/what-is-data-integrity; retrieved on: Jun. 13, 2019] while data validation is a pre-requisite for data integrity. [Source: https://digitalguardian.com/blog/what-data-integrity-data-protection-101; retrieved on: Jun. 12, 2019] Data integrity is the opposite of data corruption. [M. G. Michael; “Uberveillance and the Social Implications of Microchip Implants: Emerging Technologies] The overall intent of any data integrity technique is the same: ensure data is recorded exactly as intended (such as a database correctly rejecting mutually exclusive possibilities,) and upon later retrieval, ensure the data is the same as it was when it was originally recorded. In short, data integrity aims to prevent unintentional changes to information. Data integrity is not to be confused with data security, the discipline of protecting data from unauthorized parties. Any unintended changes to data as the result of a storage, retrieval or processing operation, including malicious intent, unexpected hardware failure, and human error, is failure of data integrity. If the changes are the result of unauthorized access, it may also be a failure of data security. Depending on the data involved this could manifest itself as benign as a single pixel in an image appearing a different color than was originally recorded, to the loss of vacation pictures or a business-critical database, to even catastrophic loss of human life in a life-critical system.

Reference to “data partition handler” implies a reusable transformation logic independent of a specific transport protocol.

Reference to “data partitioning” implies a division of a logical database or its constituent elements into distinct independent parts. Database partitioning is normally done for manageability, performance or availability reasons, or for load balancing.

Reference to “decryption” implies a process in which encrypted data is converted into its original (digital or electronic) form using, for example (but without limitation thereto) a protect or correct key.

Reference to “Diffie-Hellman key exchange” implies a method of securely exchanging cryptographic keys over a public channel. The Diffie-Hellman key exchange method allows two parties that have no prior knowledge of each other to jointly establish a shared secret key over an insecure channel. This key can then be used to encrypt subsequent communications using a symmetric key cipher.

Reference to “DNSSec” refers to Domain Name System Security Extensions (DNSSEC), which is a suite of Internet Engineering Task Force (IETF) specifications for securing certain kinds of information provided by the Domain Name System (DNS) as used on Internet Protocol (IP) networks. It is a set of extensions to DNS which provide to DNS clients (resolvers) origin authentication of DNS data, authenticated denial of existence, and data integrity, but not availability or confidentiality.

Reference to “encryption” implies a process of encoding a message or information in such a way that only authorized parties can access it and those who are not authorized cannot. Encryption does not itself prevent interference, but denies the intelligible content to a would-be interceptor. In an encryption scheme, the intended information or message, referred to as plaintext, is encrypted using an encryption algorithm—a cipher—generating ciphertext that can be read only if decrypted. For technical reasons, an encryption scheme usually uses a pseudo-random encryption key generated by an algorithm. It is in principle possible to decrypt the message without possessing the key, but, for a well-designed encryption scheme, considerable computational resources and skills are required. An authorized recipient can easily decrypt the message with the key provided by the originator to recipients but not to unauthorized users.

Reference to “key”, in cryptography, implies a piece of information (a parameter) that determines the functional output of a cryptographic algorithm. For encryption algorithms, a key specifies the transformation of plaintext into ciphertext, and vice versa for decryption algorithms. Keys also specify transformations in other cryptographic algorithms, such as digital signature schemes and message authentication codes.

Reference to “key exchange” refers to an algorithm that allows for the creation of a session key as used in symmetric key cryptography.

Reference to “key management” implies the management of cryptographic keys in a cryptosystem. This includes dealing with the generation, exchange, storage, use, crypto-shredding (destruction) and replacement of keys. It includes cryptographic protocol design, key servers, user procedures, and other relevant protocols. [Source: Turner, Dawn M. “What Is Key Management? A CISO Perspective”; Cryptomathic; Retrieved on: May 30, 2016].

Reference to “key store” refers to a secure file that contains keys used for key based cryptography.

Reference to “modular programming” implies a software design technique that emphasizes separating the functionality of a program into independent, interchangeable modules, such that each contains everything necessary to execute only one aspect of the desired functionality. A module interface expresses the elements that are provided and required by the module. The elements defined in the interface are detectable by other modules. The implementation contains the working code that corresponds to the elements declared in the interface. Modular programming is closely related to structured programming and object-oriented programming, all having the same goal of facilitating construction of large software programs and systems by decomposition into smaller pieces, and all originating around the 1960s. While the historical usage of these terms has been inconsistent, “modular programming” now refers to high-level decomposition of the code of an entire program into pieces: structured programming to the low-level code use of structured control flow, and object-oriented programming to the data use of objects, a kind of data structure.

Reference to “module” implies a discrete piece of code which can be independently created and maintained to be used in different systems.

Reference to “network” implies a digital telecommunications network which allows nodes to share resources. In computer networks, computing devices exchange data with each other using connections (data links) between nodes. These data links are established over cable media such as wires or optic cables, or wireless media such as Wi-Fi. Network computer devices that originate, route and terminate the data are called network nodes. Nodes are generally identified by network addresses, and can include hosts such as personal computers, phones, and servers, as well as networking hardware such as routers and switches. Two such devices can be said to be networked together when one device is able to exchange information with the other device, whether or not they have a direct connection to each other. In most cases, application-specific communications protocols are layered (i.e. carried as payload) over other more general communications protocols. This formidable collection of information technology requires skilled network management to keep it all running reliably.

Reference to “network host” implies a computer connected to a computer network. A host may work as a server offering information resources, services, and applications to users or other nodes on the network. Hosts are assigned at least one network address. A computer participating in networks that use the Internet protocol suite may also be called an IP host. Specifically, computers participating in the Internet are called Internet hosts, sometimes Internet nodes. Internet hosts and other IP hosts have one or more IP addresses assigned to their network interfaces. The addresses are configured either manually by an administrator, automatically at startup by means of the Dynamic Host Configuration Protocol (DHCP), or by stateless address autoconfiguration methods. Network hosts that participate in applications that use the client-server model of computing, are classified as server or client systems. Network hosts may also function as nodes in peer-to-peer applications, in which all nodes share and consume resources in an equipotent manner.

Reference to “non-repudiation” implies “the assurance that someone cannot deny the validity of something. Non-repudiation is a legal concept that is widely used in information security and refers to a service, which provides proof of the origin of data and the integrity of the data. In other words, non-repudiation makes it very difficult to successfully deny who/where a message came from as well as the authenticity of that message. Digital signatures (combined with other measures) can offer non-repudiation when it comes to online transactions, where it is crucial to ensure that a party to a contract or a communication can't deny the authenticity of their signature on a document or sending the communication in the first place. In this context, non-repudiation refers to the ability to ensure that a party to a contract or a communication must accept the authenticity of their signature on a document or the sending of a message.” [Source: https://www.cryptomathic.com/products/authentication-signing/digital-signatures-faqs/what-is-non-repudiation; Retrieved on: Jun. 13, 2019].

Reference to “one-time-pad” implies an encryption technique that cannot be cracked, but requires the use of a one-time pre-shared key the same size as, or longer than, the message being sent. In this technique, a plaintext is paired with a random secret key (also referred to as a one-time pad). Then, each bit or character of the plaintext is encrypted by combining it with the corresponding bit or character from the pad using modular addition. If the key is (1) truly random, (2) at least as long as the plaintext, (3) never reused in whole or in part, and (4) kept completely secret, then the resulting ciphertext will be impossible to decrypt or break. [Source: “Intro to Numbers Stations”; Archived from the original on 18 Oct. 2014; Retrieved on: Sep. 13, 2014; One-Time Pad (OTP)“; Cryptomuseum.com. Archived from the original on 2014 Mar. 14. Retrieved on Mar. 17, 2014]. It has also been proven that any cipher with the perfect secrecy property must use keys with effectively the same requirements as OTP keys. [Source: Shannon, Claude (1949). “Communication Theory of Secrecy Systems”. Bell System Technical Journal. 28 (4): 656-715.] Digital versions of one-time pad ciphers have been used by nations for some critical diplomatic and military communication, but the problems of secure key distribution have made them impractical for most applications.

Reference to “partitioning algorithm” implies an algorithm that accepts data and creates multiple distinct data subsets.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Reference to “public-key cryptography” implies a cryptographic system that uses pairs of keys: public keys which may be disseminated widely, and private keys which are known only to the owner. The generation of such keys depends on cryptographic algorithms based on mathematical problems to produce one-way functions. Effective security only requires keeping the private key private; the public key can be openly distributed without compromising security. [Source: Stallings, William (3 May 1990). Cryptography and Network Security: Principles and Practice. Prentice Hall. p. 165.]

Reference to “raw data” implies data that has been processed by the present invention for decryption or data that is being processed by the present invention for encryption.

Reference to “steganography” is the practice of concealing a file, message, image, or video within another file, message, image, or video. Steganography includes the concealment of information within computer files. In digital steganography, electronic communications may include steganographic coding inside of a transport layer, such as a document file, image file, program or protocol. Media files are ideal for steganographic transmission because of their large size. For example, a sender might start with an innocuous image file and adjust the color of every hundredth pixel to correspond to a letter in the alphabet. The change is so subtle that someone who is not specifically looking for it is unlikely to notice the change.

Reference to “symmetric-key cryptography” implies algorithms for cryptography that use the same cryptographic keys for both encryption of plaintext and decryption of ciphertext. The keys may be identical or there may be a simple transformation to go between the two keys. [Source: Kartit, Zaid (February 2016). “Applying Encryption Algorithms for Data Security in Cloud Storage, Kartit, et al”. Advances in ubiquitous networking: proceedings of UNet15: 147.] The keys, in practice, represent a shared secret between two or more parties that can be used to maintain a private information link. [Source: Delfs, Hans & Knebl, Helmut (2007). “Symmetric-key encryption”. Introduction to cryptography: principles and applications.] This requirement that both parties have access to the secret key is one of the main drawbacks of symmetric key encryption, in comparison to public-key encryption (also known as asymmetric key encryption). [Source: Mullen, Gary & Mummert, Carl (2007). Finite fields and applications. American Mathematical Society. p. 112; “Demystifying symmetric and asymmetric methods of encryption”. Cheap SSL Shop. 2017 Sep. 28.]

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### Terminology

The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of example-related language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . “, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of format claims, such replacements operate to create yet other alternative embodiments” consisting essentially of only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128s or 256-bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini.™., C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., web site owners or operators) place multimedia information (e.g., text, graphics, audio, video, animation, and other forms of data) at specific locations on the Internet referred to as webpages. Websites comprise a collection of connected, or otherwise related, webpages. The combination of all the web sites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, those skilled in the art will readily recognize, in view of the teachings of the disclosed embodiments, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself is transitory.

### Introduction

Cryptography deals with the securing of digital data referring, generally, to the design of mechanisms based on mathematical algorithms that provide fundamental information security services, e.g., establishing a large database of resources containing various techniques for security applications. [Source: https://www.tutorialspoint.com/cryptography/modern cryptography.htm; Retrieved on: Jun. 14, 2019]. Cryptography seeks to provide the following services: (1) confidentiality; (2) data integrity; (3) authentication; and, (4) non-repudiation. In a cryptography-related context, confidentiality refers to retention of confidential information from an unauthorized person or third party. Data integrity refers to handling the identification of any alterations to encrypted data; which may be altered either intentionally or by accident. Data integrity evaluation services confirm whether inspected data is intact or not since its most recent creation, transmission, or storage by an authorized user. Authentication refers to the provision of the identification of the data originator. Authentication confirms to the receiver that received data has in fact been sent only be an identified and verified sender. And, non-repudiation refers to a security services that ensures an entity cannot refused the ownership of a previous commitment or an action as assured by the original creator of the data, who cannot deny its creation or transmission to a recipient or third party. [Source: https://www.tutorialspoint.com/cryptography/modern cryptography.htm; Retrieved on: Jun. 14, 2019].

Advances in modern cryptography have resulted in proportionate increased demands on databases, such that the division of databases into their logical or constituent elements through a process known as data or database partitioning is done for data manageability, performance, availability or for load balancing. Thus, integrating partitioning methods and functionality into cryptographic applications can introduce data processing performance enhancements. Relying on key-based cryptography for data security, inclusive of configurable encryption and decryption systems using data partitioning and the application of multiple keys and key-based algorithms, can greatly benefit or otherwise improve upon methods for secure data storage, email, private messaging and network communications.

### General Description of the Disclosed Embodiments

The disclosed embodiments generally relate to the encryption and subsequent decryption of computer-based data using a set of keys and/or key-based algorithm pairs. Data may be divided into discrete partitions prior to the application of a key and an algorithmic rule pair to each partition. Results may be assembled into an encrypted message, which can only be decrypted by partitioning in the exact same manner used during encryption, e.g., by applying the correct key and algorithm pair to each encrypted partition. Such a technique of encryption using multiple keys and algorithms may provide a higher level of data security and may therefore be more resilient to “brute force”, “man in the middle” and other computer-based “hacking” attacks than a single key, single algorithm cryptography.

By way of example and without limitation, at least some of the presently disclosed embodiments utilize a multi-step process involving: acquiring data, reversing an offset operation for decryption, partitioning the data, applying key-based cryptography to each partition, assembling the encrypted/decrypted message in a single pass, and applying the offset operation for encryption. A configurable and modular cryptography handler allowing for the inclusion and application of any encryption algorithm is provided, including all single key and dual key algorithms as well as for facilitating the inclusion and application of partitioning algorithms. A security controller is provided for receiving, storing and retrieving offsets, session keys and identifiers for configured partitioning and cryptographic algorithms.

### System Structure

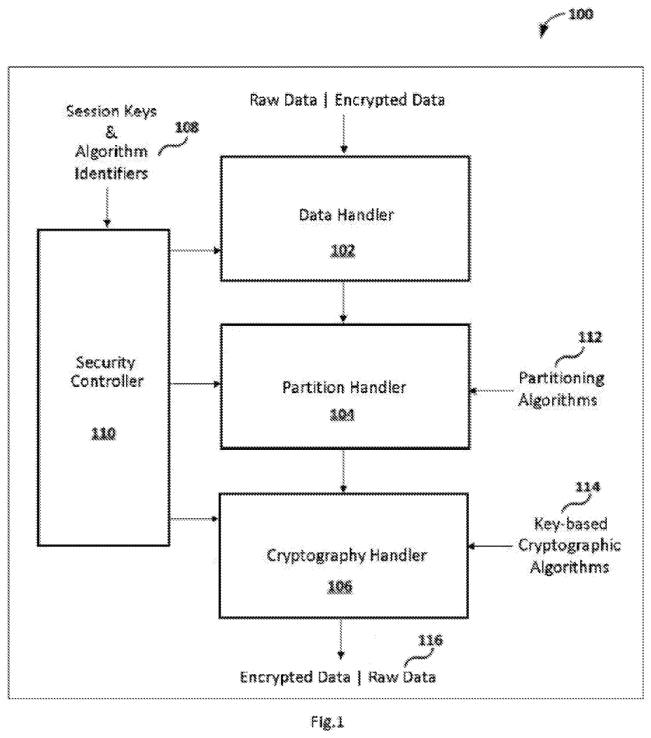

FIG. 1 illustrates an exemplary flow diagram of a modular and configurable single-pass, multi-partition, multi-key and multi-algorithm cryptographic system in accordance with an embodiment of the present invention. In the present embodiment, by way of example and not limitation, data, e.g., raw data and/or encrypted data, may be input into a cryptographic system 100 via a data handler 102, which as understood in the art and as defined herein refers to a reusable transformation logic independent of a specific transport protocol like Java Message Service (“JMS”), Hyper Text Transfer Protocol (“HTTP”), Universal Serial Bus (“USB”), Integrated Drive Electronics (“IDE”), among others. Data handlers can be configured on multiple data bindings which will be used to both acquire data and to store the results. A data binding could be a network interface, a local disk drive, a USB, WiFi or Bluetooth accessible drive, among other sources. One data binding could be used to acquire data for an operation and a different data binding could be used for either storing or sending the results of the operation.

Returning to the cryptographic system 100 shown in FIG. 1, the data handler 102 receives data and, if applicable, an identifier regarding a type of an operation performed on the data, from a security controller 110. Data, e.g., numerical and/or wireless telecommunications-related data, financial data, etc., may be acquired for any suitable source, such as (but not limited to): a local file system, a local network, a virtual network, Wi-Fi, cellular, USB, Bluetooth or another form of digital communication. In an embodiment, the cryptographic system 100 may be configured to handle any type of data, including (but not limited to): plain text, formatted, compiled, encoded, compressed or encrypted. The data handler 102 computes the size of received data in bytes and may also apply simple transformation operations, e.g., also referred to as “transforms” to the data including (but not limited to): byte encoding or padding. As generally understood in the art and as defined herein, in computing and/or cryptographic applications, data transformation refers to a process of converting data from one format or structure into another format or structure. It is a fundamental aspect of most data integration [source: CIO.com. Agile Comes to Data Integration. Retrieved from: https://www.cio.com/article/2378615/data-management/agile-comes-to-data-integration.html; retrieved on: Jun. 15, 2019] and data management tasks such as data “wrangling”, data warehousing, data integration and application integration. Data transformation can be simple or complex based on the required changes to the data between the source (initial) data and the target (final) data. Data transformation is typically performed via a mixture of manual and automated steps. [Source: DataXFormer. Morcos, Abedjan, Ilyas, Ouzzani, Papotti, Stonebraker. An interactive data transformation tool. Retrieved from: http://livinglab.mit.edu/wp-content/uploads/2015/12/DataXFormer-An-Interactive-Data-Transformation-Tool pdf on Jun. 15, 2019]. Tools and technologies used for data transformation can vary widely based on the format, structure, complexity, and volume of the data being transformed. Regarding transforms, in an embodiment, certain key-based cryptographic algorithms used by and/or applied to cryptographic system 100 may demand or require specific data block sizes and/or data “padding” may be necessary. Data “padding”, as understood in the art and defined herein, refers to the way data is arranged and accessed in computer memory. It consists of three separate but related issues: data alignment, data structure padding, and packing. Padding can be used to achieve seamless assembly after encrypting a partition. Some encryption algorithms inflate the data that is being encrypted. Adding padding before or after the operation can help during the retrieval of the specific encrypted partitions during decryption. Padding may also be necessary for some key based cryptographic algorithms due to data input size requirements. These are known issues in many existing cryptographic systems.]

By way of example and not limitation, stream-based data, e.g., streaming data, may be used for input into cryptographic system 100 for both encryption and decryption. As understood in the art and defined herein, “streaming data” refers to data that is continuously generated by different sources. Such data should be processed incrementally using stream processing (e.g., a computer programming paradigm) techniques without having access to all of the data. In addition, “concept drift” may happen in the data, meaning that the properties of the stream may change over time.

In cryptographic system 100, the security controller 110, upon receipt of session keys and/or algorithm identifiers 108, may pass data of a desired block size to data handler 102. In an embodiment, a stream identifier (not shown in FIG. 1), such as a network interface, an audio or video stream or virtual private network (“VPN”) may be associated with data handler 102 such that the security controller 110 also passes the desired block of data through the stream identifier. The size of the data block may be tailored to a size of a maximum transmission unit of a network, or otherwise may be based on maximizing a throughput of an encryption or decryption operation, or other criteria.

The data handler 102 may pass the acquired data and size thereof to a partition handler 104. Data partitioning, as performed or otherwise accomplished by partition handler 104, refers to the division of raw data into separate partitions using reversible algorithms which may be very simple or very complex. This is not the same as data partitioning for databases or partitioning for physical disk drives, although both are related operations. Database partitioning as it applies to security refers to dividing structured data such that privileged information is separated from non-privileged information. Disk partitioning as it applies to security may refer to creating a non-writable boot partition or creating partitions with restricted access.

Partitioning, as shown herein with respect to FIGS. 1-5, can be seen as a single, separate step that is applied to the entire data set prior to applying cryptographic algorithms. However, in many cases, partitioning only needs to be done prior to applying a cryptographic algorithm and both the partitioning algorithm and the cryptographic algorithm can be combined into a single rule. Combining the partition and cryptographic rules would be useful for on-demand or streaming operations or when the cryptographic algorithms do not require the entire raw message data to be present before operations begin, such as block-chain or journaling cryptography. In order to use multiple keys and key-based cryptographic methods in a single pass, the data must be partitioned, otherwise the cryptographic operation would be applied to the entire data set requiring multiple passes. Existing systems either use a single key over the entire data set or apply multiple keys in multiple passes.

The above is a description of data partitioning for a database which is a static configuration of a physical media and has completely different goals than data partitioning as used herein. Data partitioning in the current invention is modularized and it is expected that users will have many distinct rules available including their own custom rules (although it is not a requirement). Data partitioning could be as simple as striping, as is frequently used during disk partitioning, or it may be multiple complex operations. Any partition operations performed only need to be reversible during decryption to be useful.]

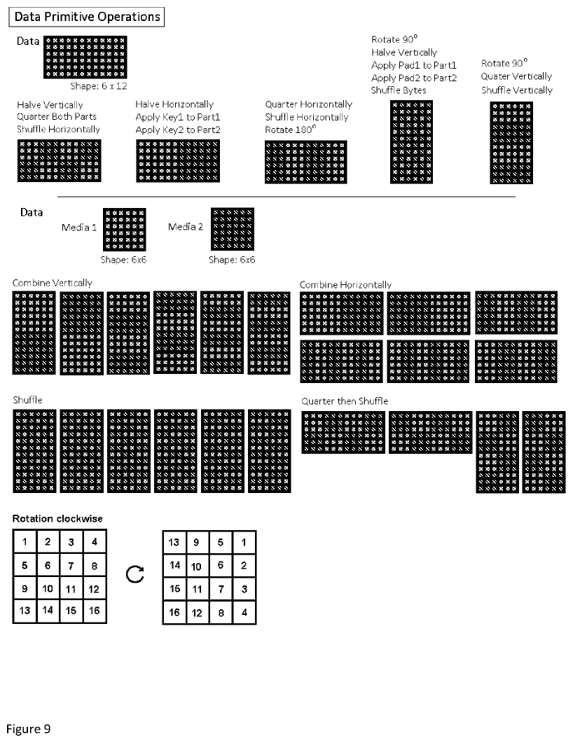

Returning to cryptographic system 100 shown in FIG. 1, partitioning algorithms, such as (but without limitation thereto) any one or more of that discussed above, refer to modules that can be manually created, read from a local encrypted storage, or otherwise acquired from a network or cloud device. The partition handler 102 may create a list of identifiers for each of the configured partitioning algorithms and provides the list to the security controller 110, the list then being used to determine an algorithm identifier therefrom. Identifiers could be the name of a specific module, e.g., VegasShufflel or Stripe20303020, or an index into a local or remote rule store. The partition module will have the encryption rule and the decryption rule. For simple algorithms, it may be the same rule (divide by 2, acquire 2000 bytes of data), for more complex algorithms, it may be the same set of rules done in reverse. FIG. 9 shows examples of partitioning algorithms. It should be noted that the same algorithms can be used when assembling and disassembling the encrypted partitions.

Partitioning algorithms 112, such as any one or more of those presented above, receives data as input there-into and creates a number of distinct data partitions by applying a rule or set of rules to the data and may be fed into the partition handler 104. The partitioning algorithms 112 functionally integrate with partition handler 104 for a determination of the number of partitions created, the size of each partition, whether the partitions are composed of contiguous or non-contiguous data, and whether the partitions are of the same or different sizes. In an embodiment, partitioning algorithms 112 may shape data using two or three-dimensional shapes to perform geometric operations on the data, including (but not limited to): division, rotation, stacking, shuffling, and combination. Such partitioning methods and techniques associated with partitioning algorithms 112 offer several data processing, management, and manipulation-related advantages. By way of example and not limitation, the number of operations used by a partitioning algorithm during a session increases the number of factors needed by an adversarial third-party to decrypt and a message encrypted, at a minimum, by data partitioning. Such partitioning algorithms only require that partitioning operations must be reversible. Decryption depends upon an exact starting point using the exact key and the exact algorithm. Each partition adds a new starting point that must be determined, as well as the exact key and algorithm used. If partitioning was not used, then each key would be applied to the output of the last key which can be considered multi-pass cryptography. However, according to embodiments descried herein, data can be partitioned so that multiple keys and algorithms can be used in a single pass.

For virtually all key-based cryptographic systems, the starting byte of data must be exact during decryption. Because of this, encrypted blocks are often preceded by a header and followed by a footer to prevent mis-alignment. The partition module implements seamless joining of secure data that has been encrypted by multiple keys and algorithms. Excluding, and in some cases removing, headers and footers to provide seamless joining of disparate cryptographic blocks is a major factor to prevent attackers from unauthorized activity.

Data, after being partitioned by partition handler 104 as dictated by the partitioning algorithms 112, may be supplied to a cryptography handler 106 supplied with one or more key-based cryptographic algorithms 114. The cryptography handler 106, in an embodiment, may include an application programming interface (“API”) to enable software developers to add security based on cryptography-related applications.

Both the cryptographic and partitioning algorithms are modular. Most cryptographic libraries work similarly where there are commonly multiple algorithms and families of algorithms present in a library. Partitioning, as shown in FIG. 9, is extremely customizable as there are hundreds, if not hundreds of thousands, of operations that can be done on data when creating a set of partitions. The only requirement is that the partitioning disassembly be reversible. If the encrypted partitions have headers and/or footers, then disassembly is trivial. If the encrypted partitions are seamlessly appended, then the partition sizes needs to be determinable. There are several techniques for this, including using algorithms that produce determinable block sizes during encryption and/or padding. Partitioning can be seen as a single, separate step that is applied to the entire data set prior to applying cryptographic algorithms, however, in many cases, partitioning only needs to be done prior to applying the current cryptographic algorithm and both algorithms can be combined into a single rule. Combining the partition and cryptographic rules would be useful for on-demand or streaming operations or when the cryptographic algorithms do not require the entire raw message data to be present before operations begin, such as block-chain or journaling cryptography.

Generally, key-based authentication or public-key authentication refers to a type of authentication available for use as a substitute to password-based authentication. For instance, instead of requiring a user's password, key-based authentication permits for confirmation of a user, client, server, or other computing location and/or device's identity by using asymmetric cryptography algorithms with public and private keys. [Source: http://www.crypto-it.net/eng/tools/key-based-authentication.htmlv; Retrieved on: Jun. 15, 2019.] By way of example and not limitation, the public keys may be disseminated widely, and private keys may be kept to only the owner. Accordingly, any person can encrypt a message using the receiver's public key, but that encrypted message can only be decrypted with the receiver's private key. Thus, key-based cryptographic algorithms 114, functionally integrated or otherwise combined with the cryptography handler 106, complete the transformation of raw data to encrypted data 116 as effectuated via the cryptographic system 100. Only the owner can use the private key for encryption but anything encrypted with the private key can be decrypted with the public key. One aspect of the current invention is that private keys can be known to multiple parties as the key usage may be limited to ensure only secrecy between the parties. That is, if non-repudiation is not desired or is provided by a separate key, private keys can be shared and a private/public key pair could be used by both parties during secure communications.

A system according to embodiments of the invention can be configured to work on data of any size or format from any source. Embodiments can handle raw data as well as encrypted or encoded data. Further, embodiments can be used manually, as a local service, on a router, on a network segment or in the cloud.

Those skilled in the art will readily recognize, in view of the teachings of the disclosed embodiments, that other suitable orders, configurations, or orientations of handlers 102-106 shown in cryptographic system 100 may exist without departing from the scope and spirit of the disclosed embodiments. Moreover, handlers 102-106 may be, in an embodiment, practiced in a reverse or any other order to decrypt encrypted data as desirable by, for example (but without limitation thereto), an end-user.

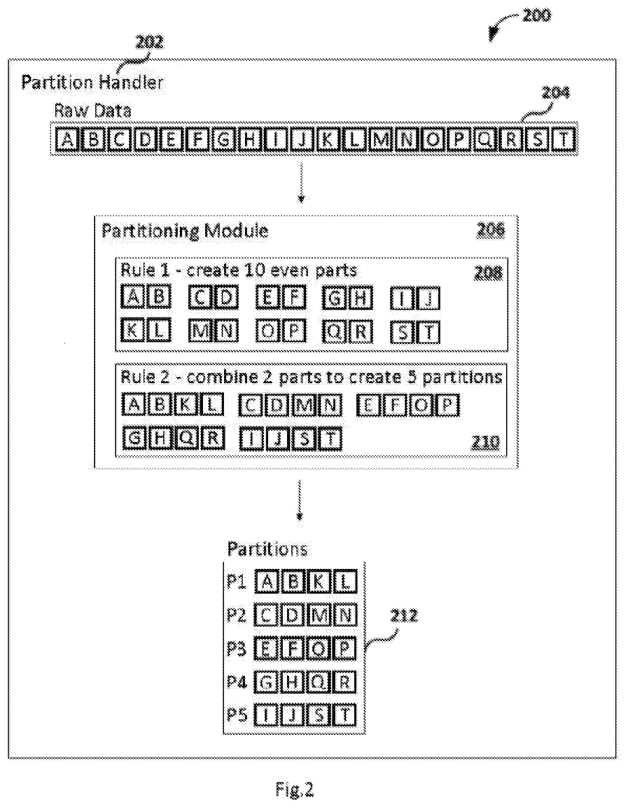

FIG. 2 illustrates an exemplary partition handler during an encryption and/or a partitioning algorithm operation in accordance with an embodiment of the present invention. In the present embodiment, a system 200 includes a partition handler 202 that may perform an encryption or a partitioning algorithm operation in which raw data 204, e.g., denoted by the “ABCD . . . etc.” sequence shown in FIG. 2, may be supplied to a partitioning module 206, which, in an embodiment, includes the performance or implementation of two rules: (1) a first rule 208 (also referred to as “Rule 1”); and, (2) a second rule 210 (also referred to as “Rule 2”).

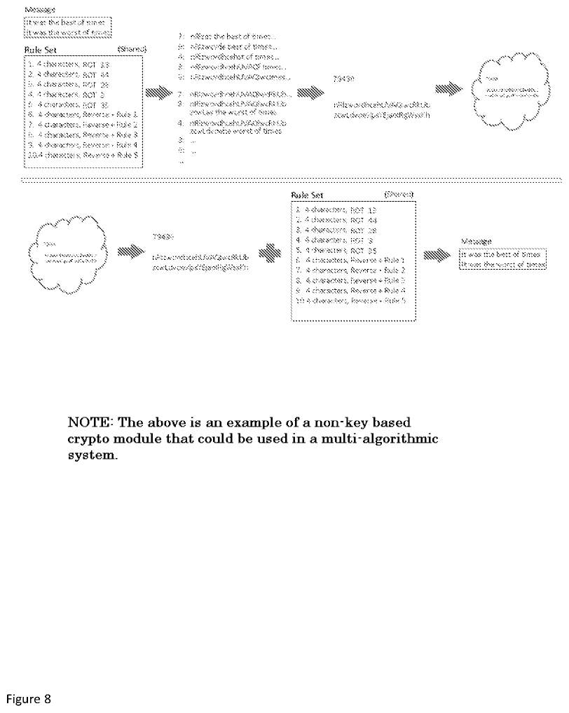

Partitioning is modular and it is expected there will be multiple partition modules in a given system, some or all could be formulaic. The treatment of uneven parts is not shown with respect to FIG. 2, however it could be handled by having the last partition contain an uneven number of letters (blocks), or by padding the data to an even length. There could be a partition module for each example. Any data can be used and A thru T should be understood to represent blocks of data. Blocks are labeled A thru T so that the partitioning algorithm used in this case would be easier to understand. Most key-based cryptographic algorithms require a minimum block size of multiple bytes, usually equal to or a multiple of 512 bytes, so ideally each block would be much larger than the minimum block size. For example, FIG. 8 shows a text message, and FIG. 9 shows the data as a set of boxes, where again each box could represent varying units of data. Some key-based cryptographic algorithms may require padding to achieve a minimum block length, which can be added in pre or post processing. Also, in some cases padding may improve the disassembly of encrypted partitions during decryption.]

By way of example and not limitation, the first rule 208 may split the incoming raw data 204 in ten even-sized parts, each part of the ten even-sized parts having contiguous data. As shown in FIG. 2, the first rule 208 may aggregate and/or partition raw data 204 into individual groupings or partitions, each partition having consecutive data entries, e.g., a first grouping of “AB”, a second grouping of “CD”, a third grouping of “EF” and so on and so forth. Those skilled in the art will readily recognize, in view of the teachings of the disclosed embodiments, that the general configuration of the various partitions of consecutive lettering is provided as an example representative of partitioning of raw data 204 and that other data values and/or grouping or partition types and/or lengths may exist without departing from the scope and spirit of the disclosed embodiments.

Data partitioned according to first rule 208 may be further partitioned by second rule 210 to aggregate two non-contiguous data parts according to that shown by FIG. 2. By way of example and not limitation, implementation of first rule 208 results, as discussed earlier, in the partitioning of data into ten contiguous data segments or partitions, each partition being composed of two consecutive letters. The ten partitions are organized in a table-like manner, the table having five columns and two rows. Data partitions above one-another are aggregated to form partitions as shown by FIG. 2 for the second rule 210, e.g., “AB” and “KL” are aggregated upon implementation of the second rule 210 to form data partition “ABKL” and so on and so forth. Such aggregation may continue until implementation of second rule 210 results in the formation of five even-sized partitions 212, e.g., partition “P1” through partition “P5” as shown in FIG. 2.

Those skilled in the art will understand in view of the description of FIG. 2 that there may be a multitude of ways to partition data and multiple partitioning modules may be used to satisfy the many different ways of partitioning data. Partitioning is a factor and it is expected that users would have multiple private partitioning modules synchronized between communicating nodes. It is also possible to employ a third party rule store to provide session parameters.

The example shown could just as easily create 8 partitions or 12 partitions or any number of partitions. Further, the partitioning could be based on a set or variable byte length, a percentage of the total data (if known), or any number of methods.

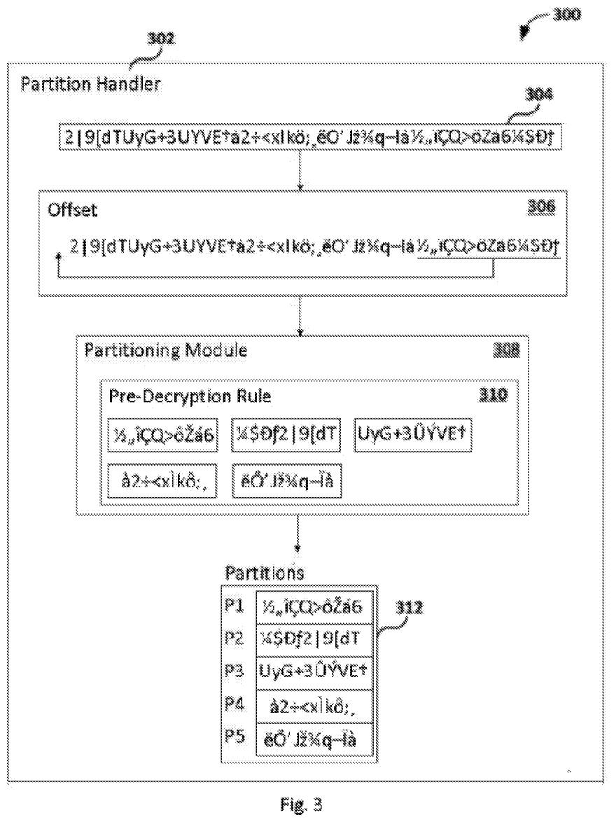

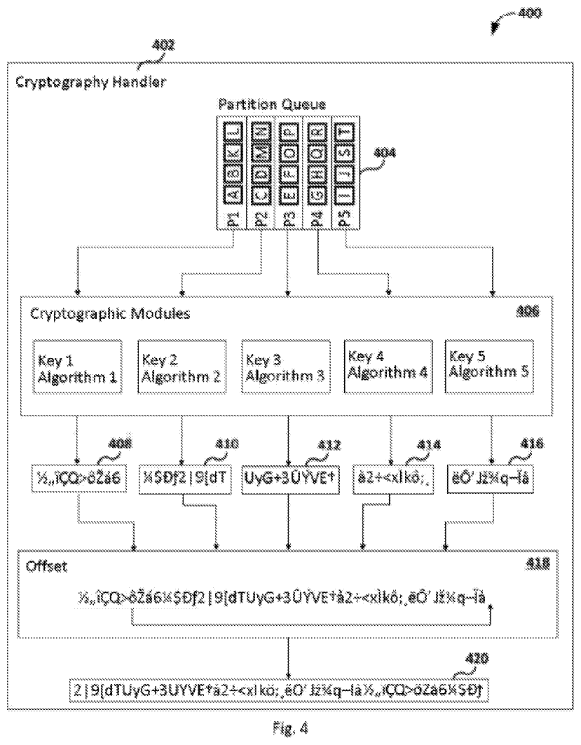

FIG. 3 illustrates an exemplary partition handler during a decryption and/or a partitioning algorithm operation in accordance with an embodiment of the present invention. In the present embodiment, a system 300 includes a partition handler 302 performing a decryption and/or a partitioning algorithm operation in which encrypted data 304 may have been encrypted by, for example (but without limitation thereto), any combination of one or more of the cryptography handler 106 shown in FIG. 1 and/or the like. Encryption of data contained in partitions 212 is further described in connection with FIGS. 4-6 and may include, generally, any one or more of the application or implementations of an offset operation and other cryptographic algorithms and/or rules. Implementation of the cryptographic algorithms and/or rules to the raw data in partitions 212 may, in an embodiment, include usage of keys, pads and media that are combined in unique and different ways to create rules, where each rule thereof may determine how and how much data to process. Rules can also reference other rules and can be of arbitrary complexity. Decryption may involve process knowledge of what algorithms, keys, pads and media were used or applied, how they were used, and in what particular order.

Returning to partition handler 302 engaged in a decryption operation as shown in FIG. 3, an offset operation 306 passed by the security controller 110 (shown in FIG. 1) may be reversed according to rules and/or algorithms that match those implemented for encryption. The decryption partition handler 302 matches (e.g., in terms of modules and/or configuration) encryption partition handler 202 (shown in FIG. 2) and thus may also be configured to have two rules (as in partitioning module 206) such that a first of the two rules of decryption partition handler 302 is implemented prior to decryption operations and the second rule thereafter, as denoted generally by a partitioning module 308. In an embodiment, the first (e.g., pre-decryption) rule of the partitioning module 308 divides encrypted data 304 supplied thereto (after the encrypted data first undergoes reversal of the offset operation 306) into, by way of example and not limitation, five partitions, e.g., pursuant to a pre-decryption rule 310 intended to reverse second rule 210 shown in FIG. 2 during encryption. The first rule 208 (shown in FIG. 2) may also be reversed by a post-decryption rule (not shown in FIG. 3), in an embodiment, after the cryptography handler 106 (shown in FIG. 1) has decrypted partitions 312. By way of example and not limitation, the post-decryption rule may be applied by partition handler 302, or be provided to the cryptography handler 106 as a module or as a callback function, e.g., referring to any executable code that is passed as an argument to other code that is expected to call back the argument at a given time. The partitioning and assembly used during encryption must match the disassembly and reassembly used during decryption. If an attacker attempts to decrypt a message using either the wrong starting point of a partition, the wrong key or the wrong algorithm, then the operation will fail. Note that the number of key and algorithm pairs used does not need to match the number of partitions and key pairs can be reused during an operation.

Those skilled in the art will readily recognize, in view of the teachings of the disclosed embodiments, that the configurations of encryption partition handler 202 shown in FIG. 2 and decryption partition handler 302 are provided as examples and that other suitable configurations may exist without departing from the scope and spirit of the disclosed embodiments. Additional methods, in one or more embodiments, may be provided regarding creating custom partitioning modules and/or algorithms, e.g., such that any number of partitions may be created and reversed pursuant to dividing and re-combining encrypted and decrypted data, respectively, in an arbitrarily large number of ways. Such custom algorithms provide an increased level of security over traditional methods of encrypted communications due to the vast number of possible partitioning algorithms and/or algorithm configurations. In an embodiment, a generic rule set may be provided along with several generic modules to use that generic rule set such that custom partitioning algorithms may use the generic rules, but with different parameters and sequencing. By way of example and not limitation, a partitioning algorithm may be communicated using a secure channel and used to generate a partitioning module on-site, e.g., referring to, in cryptography and in computing more generally, the storage of code and data on a periodic basis on local storage devices, such as hard drives, DVDs, magnetic tapes, CDs and/or the like. The proposed invention can be used for network and streaming operations, such as on a Virtual Private Network (VPN) or Video on Demand, as well as for data sets of a fixed or determinant amount, such as an operation involving storing or transferring a file. In streaming and network operations, assembly and disassembly options are more limited but should not preclude seamless transitioning between encrypted partitions.

Returning to that shown in FIG. 1, the security controller 110 may, in an embodiment, identify any one or more of a cryptographic operation, a data source, session keys, and/or cryptographic and/or partitioning algorithms that may be implemented by cryptographic system 100. By way of example and not limitation, the partition handler 104 may provide a list of configured partitioning algorithms to the security controller 110. Likewise, the cryptography handler 106 may provide a list of configured cryptographic algorithms security controller 110. Accordingly, for each encryption and decryption session, e.g., as shown by FIGS. 2 and 3 respectively, the security controller 110 may pass an identifier for a specific partitioning algorithm to the partition handler 104, and may pass identifiers for the specific keys and/or cryptographic algorithms to cryptography handler 106. In an embodiment, the selection of keys and/or identifiers may be done manually, e.g., via user interaction with cryptographic system 100, using, by way of example and not limitation, using any one or more of: a stored configuration and/or negotiated using session key acquired from a trust server such as DNSSEC, Active Directory, and/or a combination of methods.

In an embodiment, the number of partitions created by a partition algorithm implemented by partition handlers 202 and/or 302 may exceed the number of key and/or key-based cryptographic algorithm pairs, where key and algorithm pairs may be implemented more than once. In such scenarios, the security controller 110 may pass a re-use protocol identifier to cryptography handler 106, the re-use protocol being defined as a set of rules that determine how keys may be re-used. Examples include (but are not limited to): repeat of key implementation order or the reversal of the key implementation order. Re-use protocols may be, in one or more embodiments, modular and stored by or in cryptography handler 106. In some cases, such as network and streaming applications, the number of partitions is only limited by the lifetime of the connection, whereas the number of keys and algorithms is usually finite over that lifetime. A key reuse strategy can be employed in those cases when the number of key algorithm pairs used exceeds the number of keys algorithm pairs configured. The reuse strategy can be considered an additional factor that an adversary would need to gain access to in order to decrypt communications. Rules can be implemented to rotate or defer key usage as well as to obtain new keys, as needed.

As shown in FIG. 1, in an embodiment, the cryptography handler 106 may accept, for example, without limitation, any one or more of session keys and/or cryptographic algorithm identifiers from security controller 110, data partitions from partition handler 104 to store key-based cryptography algorithms therein. Generally, key-based cryptography algorithms refer to software-related and/or data modules and can be manually created, read from local storage, or be otherwise acquired from an outside source. A cryptography module, in an embodiment, may have at least one or more selected from a group including the following: a single algorithm, a family of related algorithms or multiple cryptographic algorithms. A key-based cryptographic module may accept data, a key and the cryptographic operation, encryption or decryption, to perform. In an embodiment, the cryptography handler stores a list of identifiers for each of the configured key-based cryptographic modules and the algorithms they contain and provides the list to security controller 110, which provides the keys and identifiers for the algorithms that will be used to encrypt or decrypt the data during an encryption or decryption session, respectively. A key or module may be used more than once per session, and references may be applied to prevent duplication of data. Moreover, independent and distinct modules may be added, removed or modified to that shown associated with cryptographic system 100 without departing from the scope and spirit of the disclosed embodiments. Each user or node involved in secure communications use synchronized keys, algorithms and partitioning. If there is only 1 node involved, such as secure storage, than provisioning is unnecessary. In some cases provisioning will be accomplished by using a third party security provider, a secure cloud storage, a VPN, physical courier, vocally, as well as other methods, e.g., in distributed use cases.

Key-based cryptographic algorithms, as generally understood in the art and as defined herein, operate to produce encrypted data, the size (e.g., volume) of which may be determined by the cryptographic algorithm proportionate to the size of the partition and minimum block size. Encrypted partitions with calculable sizes can be seamlessly appended when creating the encrypted message. Seamless assembly adds an additional factor that must be overcome by an attacker as they must first disassemble the encrypted partitions.

Mixing various dissimilar cryptographic algorithms that do not produce the same size of encrypted data may result in the production of uneven encrypted partitions that may complicate decryption operations. In those cases, headers and/or footers may be applied between encrypted partitions, thus making it easier for an attacker to disassemble some or all of the partitions. The attacker will still need to know which keys and which algorithms were used on which of the encrypted partitions, which should still be secret. Key based cryptographic algorithms are distinct in their implementation and cannot be substituted during decryption. Even related key-based cryptographic algorithms, such as blow-fish, two-fish and three-fish, will not decrypt partitions that were encrypted using one of the other algorithms.

By way of example and without limitation, as shown in FIG. 1, the security controller 110 may supply and/or pass the identifier for a partitioning algorithm if key-based algorithms used all produce the same size of encrypted partition, e.g., each partition is of the same data size. The partition handler 104 may be passed, in an embodiment, a set of encrypted data output sizes for the key-based cryptographic algorithms used during encryption. During decryption, the partition handler 104 may accordingly determine the correct partition sizes based on, for example (but without limitation thereto), the total size of the encrypted data and the ratio of each algorithm used. Also, in an embodiment, the cryptographic system 100 may allow for the creation of the same size of encrypted partition by partition handler 104 creating partitions sized accordingly for each of key-based algorithms 114 supplied to cryptography handler 106. In such a scenario, communication of only the number of partitions created during encryption would be necessary, as the resulting encrypted message would consist of evenly sized partitions.

As shown in FIG. 1, the cryptography handler 106 accepts partitions from partition handler 104 and accepts keys and cryptographic module identifiers from security controller 110. The partition handler 104 applies to each partition, in the order passed, a configured key and a key-based cryptography module pair. In an embodiment, should the number of partitions be greater than the number of cryptographic key and algorithm pairs, then the pairs can be re-used in accordance with a re-use protocol identifier provided by security controller 110.

Consideration of sizing and workload for each data partition as defined by partition handler 104 may be vital for balancing such that data is evenly distributed to achieve maximum scalability via data partitioning operations. Nevertheless, data typically must also be partitioned without exceeding the scaling limits of a single partition store. Therefore, the partition handler 104, in one or more embodiments, may be configured to analyze data access patterns, such as the size of the result set returned by each query, the frequency of access, the inherent latency, and the server-side compute processing requirements. In some embodiments, a few major entities may demand the bulk of the available processing resources. The partition handler 104 may use this analysis to determine the current and future scalability targets, such as data size and workload to distribute data across the partitions to meet a given scalability target. For horizontal partitioning, choosing the right shard key may be important to ensure that distribution is even. In an embodiment, the partition handler 104 may ensure that each partition has enough resources to handle the scalability requirements, in terms of data size and throughput. Depending on the data store, there might be a limit on the amount of storage space, processing power, or network bandwidth per partition. If the requirements are likely to exceed these limits, it may be necessary to refine the partitioning strategy and/or split data out further, possibly combining two or more strategies. And, the partition handler 104 may monitor the system to verify that data is distributed as expected and that the partitions can handle the load. Actual usage may not always match what an analysis predicts. In such a scenario, the partition handler 104 may rebalance the partitions, or else redesign some parts of the system to gain a desired balance.

FIG. 4 illustrates an exemplary block diagram of a cryptography handler and multiple key-based cryptographic modules used for encryption in accordance with an embodiment of the present invention. In the present embodiment, a system 400 includes a cryptography handler 402 and multiple-key based modules 406 used for encryption in which data organized into a partition queue 404 may be obtained or extracted from, for example (but without limitation thereto) partitions 212, e.g., P1 through P5, produced by partition handler 202 to be passed to their corresponding key-algorithm pairs in multiple-key based modules 406 for encryption. Specifically, in an embodiment, the partition P1 may be passed to a “key 1 algorithm 1” pair to produce an encrypted partition data block 408. Likewise, in one or more embodiments, partitions P2 through P5 may be passed to their respective key-algorithm pair for encryption thereby, e.g., P2 may be passed to a “key 2 algorithm 2” pair to produce an encrypted partition data block or module 410, and so on and so forth.

Operationally, the cryptographic modules 406 and corresponding keys may be assembled into a set. The passing off of partitions to their respective key-algorithm pairs continues with each partition (e.g., P1 through P5) until there are either: (1) no more partitions left to encrypt; or, (2) the set of key and key-based cryptographic modules may be exhausted. If there are no more partitions remaining, then the encryption operation as conducted or performed by cryptography handler 402 may be considered to be complete. Further, in an embodiment, if a set of key and algorithm pairs is exhausted, then a re-use protocol (not shown in FIG. 4) may be applied and encryption may continue on remaining partitions.

After encryption of each of the partitions P1 through P5, the encrypted data from encrypted partition data block 408 is placed at the beginning of an output buffer 418, followed by the encrypted data from the subsequent encrypted partition data blocks or modules 410-416. In an embodiment, an offset operation shifting a data start point away from, for example (but without limitation thereto), the start of an encrypted partition may then be applied to output buffer 418 to produce a final encrypted message 420. Varied functionality of rules implemented by multi-algorithmic cryptography may be integrated, e.g., data partitioning followed by data encryption, etc., as illustrated in the following figures. For example, an offset operation is an optional factor that an attacker must circumvent. In some applications, such as streaming or network operations, an offset may be negotiated during connection creation or foregone completely. For static operations, an offset may be the last operation performed before final storage.

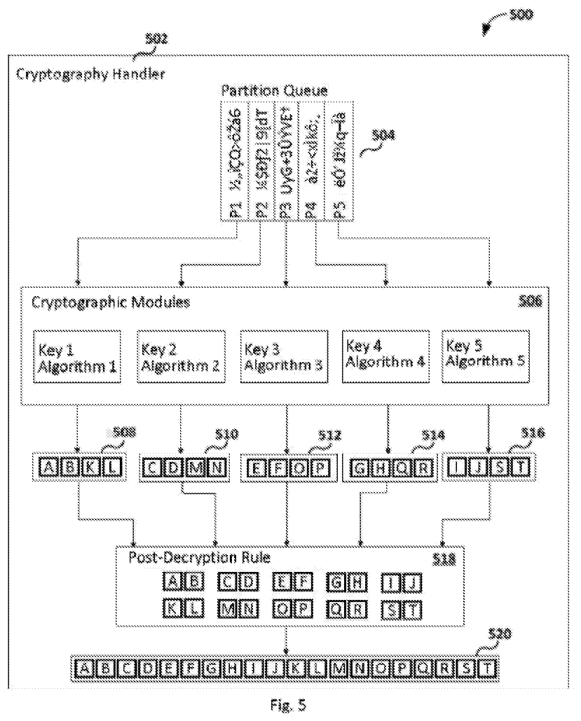

Multi-algorithmic cryptography and related techniques and/or methods, e.g., as substantially set forth by cryptography handler 402 shown in FIG. 4, may be designed to use multiple cryptographic and data primitive (e.g., referring to either of: (1) a basic type is a data type provided by a programming language as a basic building block; or, (2) a built-in type is a data type for which the programming language provides built-in support) techniques along with multiple keys and key types that may be formulated into a set of rules, offering distinctions and/or advantages over other known cryptographic methods. By way of example and not limitation, rules implemented in or by multi-algorithmic cryptography may include the following: a rule set may be arbitrarily large; any one or more rules of a given rule set may be arbitrarily complex; a cryptographic method, data primitive or key may be used in multiple rules and may also be combined in multiple ways in the same rule; rule sets can be obtained from a rule server or manually entered; and, new rules can be added to a rule set and existing rules can be deprecated. FIGS. 2 and 4 show the complete encryption life cycle of data. FIGS. 3 and 5 show the complete decryption life cycle of data. Similarly, FIG. 8 shows a non-key based cryptographic operation that partitions data 4 characters at a time and employs 5 cryptographic modules out of the 10 total cryptographic modules in the local rule store. In this configuration, the partitioning is a simple rule, acquire 4 characters worth of data, and is included with the cryptographic module.

Additional distinctions and/or advantages offered by multi-algorithmic cryptography and related techniques and/or methods may include at least the following: each rule in a given rule set may define how much of a data stream or file may be processed during encryption, decryption and pad generation and only a subset of the rule set may be used; the amount of data processed by multi-algorithmic cryptography may be a contributing factor during operations; a specific subset of rules and the order such rules may be applied may both be additional factors influencing operational performance; rules can reference other rules and also be referenced themselves; during operations, a rule can alter its own behavior and the behavior of other rules; and, rules must be reversible to be used for encryption and decryption operations.

Still further, multi-algorithmic cryptography and related techniques and/or methods may, in some embodiments, denote that: steganography is specifically not required for multi-algorithmic cryptography; or, in the alternative, steganographic methods can be incorporated as a cryptographic module or set of modules. Multiple rules can be created and represented in a rule set for multi-algorithmic cryptography using steganography. Moreover, a user may configure a rule set to only use a single steganographic technique. Drawbacks concerning the integration of steganography with multi-algorithmic cryptography include that steganography may require a modified data stream which is generally much larger than the original message. In contrast, steganography requires transmitting a carrier file which contains subtle alterations that encrypt the data. However, there is not an easy or intuitive way to include a carrier file in operations.

Those skilled in the art will readily recognize, in view of the teachings of the disclosed embodiments, that the above-described listing and explanation of functionalities and variants thereof related to multi-algorithmic cryptography is provided as an example and is non-limiting and non-exhaustive. Other suitable configurations and/or executions of multi-algorithmic cryptography may exist without departing from the scope and spirit of the disclosed embodiments.

Moreover, other cryptographic methods may exist and may be employed by cryptography handler 402 in lieu of or in combination with any one or more of the multi-algorithmic cryptographic methods presented. By way of example and not limitation, there may be some existing technologies such as transparent layer security (“TLS”) that allow two computers to negotiate a highest common cryptography profile (however, once negotiated, the method does not change and is applied to the entire message). Also, multiple cryptographic methods may be implemented in layers where a first layer is applied to the entire message and each subsequent layer is applied to the output of the layer beneath it. Layering occurs naturally in networking such as an HTTPS session over a VPN. And, systems exist regarding assessment of client's security posture and may be determined to negotiate updates and security scans to bring the client up to date (however these systems may not need to necessarily perform cryptography). FIG. 5 illustrates an exemplary block diagram of a cryptography handler and multiple key-based cryptographic modules used for decryption in accordance with an embodiment of the present invention. In the present embodiment, a system 500 includes a cryptography handler 502 and multiple key-based cryptographic modules 506 used for decryption. By way of example and not limitation, decryption operations performed by cryptographic handler 502 essentially reverse the encryption operations performed by cryptography handler 402 shown in FIG. 4 resulting in the production of decrypted data 520. Decryption operations differ from encryption operations discussed earlier in that, in some embodiments, post decryption partition processing may be necessary. As shown in FIG. 5, during decryption, a set of partitions P1 through P5 from a partition queue 504 is passed into cryptographic modules 506 of cryptography handler 502. Each partition P1 through P5 from partition queue 504 may include data encrypted via the cryptography handler 402 conducting a cryptography operation 402 as shown by system 400 in FIG. 4. Accordingly, to decrypt such encrypted data, each partition P1 through P5 from partition queue 504 may be passed to its respective key-algorithm pair. That is, encrypted data contained and/or stored within partition P1 may be passed to “key 1 algorithm 1” within the cryptographic modules to produce a corresponding decrypted partition 508 pursuant to the same rule and/or set of rules applied by the cryptographic modules 406 during encryption.

Accordingly, passage of encrypted data contained in partition P1 from partition queue 504 produces decrypted module 508 containing data “ABKL” pursuant to decryption applying in reverse, for example (but without limitation thereto), the second rule 210 (also referred to as “Rule 2” in partitioning module 206 shown in FIG. 2). Such decrypted data in decrypted module 508 may be subsequently passed to a post decryption rule 518, which, in an embodiment, performs decryption by applying, in reverse, for example (but without limitation thereto), the first rule 208 (also referred to as “Rule 1” in the partitioning module 206 shown in FIG. 2) to produce the decrypted data 520. Likewise, encrypted data from partition P2 through P5 of partition queue 504 may also pass through cryptographic modules 506 to their individual respective key-algorithm pairs, e.g., encrypted data contained in partition P2 may pass to the “key 2 algorithm 2” pair for partial decryption to “CDMN” prior to being further decrypted by post-decryption rule 518 as so described to produce decrypted data 520.

By way of example and not limitation, the cryptographic modules 506 and their corresponding key—algorithm pairs may be assembled into a set or array. The pattern of passing encrypted data contained in each partition P1 through P5 of partition queue 504 continues with each partition until there are either no more partitions to decrypt or the set of key and key-based cryptographic modules is exhausted. If there are no more partitions remaining, then the decryption operation is complete.

By way of example and not limitation, if a given set of key and algorithm pairs is exhausted, then a re-use protocol may be applied for decryption to continue on the remaining partitions. The decrypted partitions 508-516 may then be passed to post-decryption rule 518 which, as described earlier, performs post-decryption processing, in this case reassembling non-contiguous part into decrypted data 520, which, in an embodiment, may match or otherwise equal original data. As an alternative, (not shown in FIG. 5), the decrypted partitions 508-516 may be passed back to a partition handler, such as partition handler 104 for data reassembly and post-decryption processing.

Returning the cryptographic system 100 shown in FIG. 1, those skilled in the art will readily recognize, in view of the teachings of the disclosed embodiments, that various handler modules 102-106 and associated security controller 110, as well as the partitioning and key-based cryptographic algorithms 112 and 114, respectively, are provided in an example configuration and may be representative of any one or more of the modules and/or algorithms shown and discussed in connection with FIGS. 2-5. Moreover, the cryptographic system 100 shown in FIG. 1 and/or any one or more of the systems and/or modules shown and discussed in connection FIGS. 2-5 may be implemented in various pieces of computer-related hardware and/or devices, including (but not limited to): a network driver, a local service provider, a network device, as a set of micro-services distributed in a virtual or “cloud” environment, a client-service architecture on a traditional network, or embedded in an application such as chat or email. In one or more embodiments, the cryptographic system 100 shown in FIG. 1 and/or any one or more of the systems and/or modules shown and discussed in connection FIGS. 2-5 may be configured to be primarily software-based being implemented in computer hardware or as associated primarily with hardware, and/or any combination thereof.

By way of example and not limitation, the cryptographic system 100 shown in FIG. 1 and/or any one or more of the systems and/or modules shown and discussed in connection FIGS. 2-5 may include a partitioning algorithm module generator. A partition module generator may accept raw data to produce a set number of partitions.

Nevertheless, a potential limitation for a custom partitioning algorithm generator module may be or otherwise include that partitioning operations must be fully reversible to perform decryption operations. Producing a custom partitioning algorithm may also increase or otherwise enhance security since data partitioning may be or present a compounding factor. In detail, the number of ways to partition data may be relatively very large and increase proportionately according with the size of the data.

By way of example and not limitation, if multiple copies of the cryptographic system 100 shown in FIG. 1 and/or any one or more of the systems and/or modules shown and discussed in connection FIGS. 2-5 are running on multiple machines, then any one or more of the various keys and data indexes used may need to be synchronized for successful encryption and decryption operations. Further, such distribution or exchanging of keys, key-based cryptographic modules, partitioning modules and/or associated indexes may be accomplished in a variety of ways and methods, including (but not being limited to): physical media including thumb drives, portable hard-drives, tape drives and solid-state devices and/or the like. Provision keys, modules and indexes may also be applied, implemented or otherwise used over a secure network connection or through a third-party trust server. Keys and other factors can be stored in a secure manner using one or more encrypted key stores accessible by, for example (but without limitation thereto), the security controller 110.

In one or more embodiments, the selection of session keys and identifiers for cryptographic and partitioning algorithms employed by any one or more of the cryptographic system 100 shown in FIG. 1 and/or any one or more of the systems and/or modules shown and discussed in connection FIGS. 2-5 during messaging can also be accomplished in a variety of ways and methods. By way of example and not limitation, factors can be configured in advance, generated systematically, negotiated on a per-session basis using a key exchange protocol such as Diffie-Helman (e.g., referring to the Diffie-Helman method of securely exchanging cryptographic keys over a public channel; it is primarily used as a method of exchanging cryptography keys for use in symmetric encryption algorithms) or through a trust server.

A common issue facing sophisticated entities requiring demanding cryptographic solutions, e.g., large corporations, is the “travelling salesman” problem (e.g., as commonly understood in the art and as defined herein as referring to how to ensure security of assets which are used off-site and which may be exposed to unsafe environments and networks or which may be subject to inspection by third parties, such as at borders and customs.) The “travelling salesman” problem may be solved using a cryptographic key generator that rotates keys on a defined schedule. The cryptographic system 100 shown in FIG. 1 and/or any one or more of the systems and/or modules shown and discussed in connection FIGS. 2-5 may incorporate a similar cryptographic technology to cycle through keys and indexes in a secure manner. Another approach, for example (but without limitation thereto), may include or involve the storage of multiple configurations of partitioning algorithms, keys and cryptographic algorithms, which may be used when off-site. After usage the specific configuration including keys and modules may be erased from the computer running, for example (but without limitation thereto), the cryptographic system 100, meaning only the on-site system would have the correct configuration to be used for decryption. If the computer is lost, stolen or otherwise taken, any decrypted contents would still be considered secure due to the lack of the necessary configuration, algorithms and keys required for complete decryption or access to completely decrypted data.

The cryptographic handler uses cryptographic modules. Key based modules take data and a key and perform operations using an algorithm implemented by the module (in many cases a cryptographic module has more than one algorithm) to produce a block of encrypted data. The module can also perform decryption given the key and the encrypted data. Cryptographic methods, besides key-based cryptography, may be used by providing a cryptographic module for the method, which in an embodiment, must produce a determinable size of encrypted data and, when given the encrypted data, must produce the original data. Non-key based cryptographic methods that produce a fixed or determinable size of encrypted data, such as a simple cipher or one-time pad, are easily adapted for such usage. A one-time pad, or other cryptographic parameters, may need to be input into such a cryptographic module, similar to the way keys may be passed to a key-based cryptographic module. The cryptographic handler uses cryptographic modules. Key based modules take data and a key and perform operations using an algorithm implemented by the module (in many cases a module has more than 1 algorithm) to produce a block of encrypted data. The module can also perform decryption given the key and the encrypted data. Other cryptographic methods such as a one-time pad or offset cryptography operate similarly. A OTP module would take a pad and data and would produce a block of cipher text or would take a pad and cipher text and produce the original data. Because of the modularity, any cryptographic algorithm or technique can be used as long as the operations are reversible. In most cases, a truly random, securely distributed one time pad provides the highest level of security during operation, however provisioning and distributing one time pads prior to operation is costly.

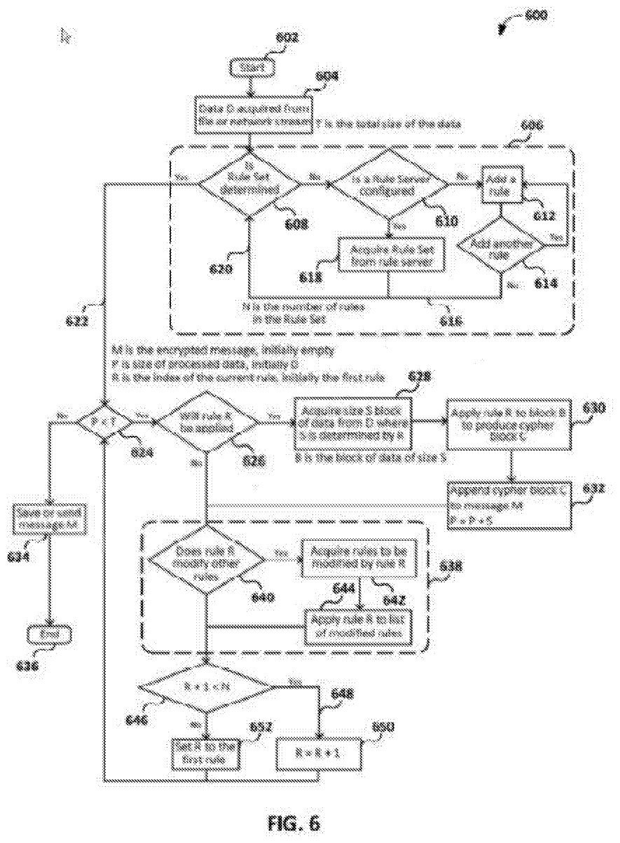

FIG. 6 illustrates an exemplary flow diagram of a method for applying a set of rules having multiple cryptographic keys, media files and algorithms to generate one-time pads (“OTP”) and to encrypt and to decrypt data in discrete parts providing message secrecy, integrity and authenticity for communications and storage in accordance with an embodiment of the present invention. In the present embodiment, a method 600 may apply a set of rules having multiple cryptographic keys, media files and algorithms to generate one-time pads (“OTP”) and to encrypt and to decrypt data in discrete parts providing message secrecy, integrity and authenticity for communications and storage. The method 600, in any one or more embodiments, may be implemented or otherwise integrated by any one or more of cryptographic system 100 shown in FIG. 1 and/or any one or more of the systems and/or modules shown and discussed in connection FIGS. 2-5 for encryption and/or decryption purposes. That is, completion of performance of method 600 may transform partitioned data into encrypted partitioned data and/or vice-versa, e.g., when undertaken in reverse. In an embodiment, the method 600 may integrate with a cryptographic system, such as cryptographic system 100 shown in FIG. 1, allowing for the implementation of a set of partitioning algorithms and a set of key based cryptographic algorithms configurable to perform encryption and decryption operations in a single pass on raw and encrypted data partitions using multiple keys. Encryption of data occurs by partitioning the raw data, applying a different key and key-based algorithm to each partition and assembling the resulting encrypted partitions into an encrypted message. Corresponding decryption of the encrypted data may be accomplished by reverse-partitioning the encrypted message, applying the specific key and key-based algorithm to each encrypted partition and assembling the decrypted partitions into the raw data.

By way of example and not limitation, the method 600 may operate substantially as follows: a start operation 602 initiates method 600 followed by an acquisition operation 604 where data “D” may be acquired from one or more files and/or network streams, where “T” may be denoted for the total size of the data. Such acquired data at the acquisition operation may be passed to a rule algorithm application region 606 including: a determination operation 608, a configuration operation 610, a rule addition operation 612, a subsequent rule addition operation 614, a final rule set determination operation 616, a rule set acquisition operation 618 and a recycle passage 620.

In operation, for example (but without limitation thereto), data acquired from the acquisition operation may be passed to determination operation 608 for the determination of an appropriate rule and/or rules for application to the data, if needed (e.g., a rule set has not been yet determined, thus yielding a determination of “no” at determination operation 608). The data may be passed to configuration operation 610 that may determine whether a rule server responsible for storing and/or applying the rule and/or rules to the data is configured. If no, then the data passes to rule addition operation 612, and, optionally, to the subsequent addition of rules to, for example, without limitation, parse, process, flip, return, manipulate, or otherwise modify the data. If yes, then a rule set is acquired from a rule server at rule set acquisition operation 618 to be applied to the data. From either or both of the rule set acquisition operation 618 and/or the subsequent rule addition operation 614, data with a rule and/or rules applied thereto may pass and/or return to determination operation 608 by recycle passage 620 after being finally characterized by final rule set determination operation 616.

Should a rule set already be determined by the determination operation 608, data may pass via a passage 622, where “M” may represent the encrypted data and/or message, initially being empty; “P” may represent the size of the processed data, initially 0; “T” may represent the total size of the data; and, “R′ may be the index of the current rule, initially the first rule identified and/or applied by, for example, without limitation, the rule algorithm application region 606.

Data passes through the passage 622 to a deciding point 624 where P is compared against T. Should P be not less than T, e.g., equal or greater to T, then the data may be saved and/or sent as message M at a save or send operation 634 to end method 600 at an end operation 636.

Alternatively, should P be less than T as calculated or otherwise determined at the deciding point 624, data may be passed to a rule application decision point. Should a determination of “yes” be provided to the application of rule R to the data, then the data may be passed to an intention of rule application operation 626. An indication of “yes” at the intention of rule application operation 626 may permit data to pass to a data size acquisition operation 628, where a size S block of data “B” from the data D may be acquired as determined by R such that ‘D=B1+B2+ . . . +Bfinal’. In an embodiment, an indication of “no” at intention of rule application operation 626 may permit data to pass and return from to an append operation 632 further described below.

A size S block of data acquired from the data D from data size acquisition operation 628 may be passed to a cypher production operation 630, where the rule R may be applied to a block “B” of the data to produce cypher block “C′, which may then be appended at an append operation 632 to the message M, e.g., such that ‘M=Cr1+Cr2+ . . . +Crfinal’, where Cr1 is the cypher block of rule 1, Cr2 is the cypher block of rule 2.

Should a determination of “no” be provided to the application of rule R to the data at the intention of rule application operation 626, data may be passed to a general rule R modification region 638, including: a modification determination operation 640, a rule acquisition operation 642, and a rule application operation 644.

In operation, data may be passed to modification determination operation 640 that assesses whether rule R modifies other rules, if “yes” then data may be passed to rule acquisition operation 642 where additional rules are acquired to be modified by rule R. Modification operations alter rules in many ways. Variables like the amount of data operated on by the rule, an offset value or a control are altered such that the next application of the rule is different from previous applications of the same rule. Modification operations can also indicate that the rule should be skipped for a number of access events or deleted entirely from the system. Data may then be passed to rule application operation 644 to apply rule R to a list of modified rules prior to the data being passed to an incremental assessment point 646, where R+1 is compared against N. Should R+1 be less than N, yielding a determination of “yes”, then the data may be passed, via a pathway 648, to a rule augmentation operation 650 where rules may be augmented according to the following formula: R_{final}=R_{incremental}+1 to return the data to deciding point 624 to repeat the assessment there until all data is assessed to be ready for saving or sending at the save or send operation 634. Should R+1 not be less than N, e.g., R+1, is equal to or greater than N, then R may be set to the first rule at a rule set operation 652 prior to the data returning to deciding point 624 for assessment therein. Those skilled in the art will readily recognize, in view of the teachings of the disclosed embodiments that the configuration of the various operations discussed for method 600 is provided as an example only and that other suitable variations of the operations may exist without departing from the scope and spirit of the disclosed embodiments. R_{final} is just the last rule applied to the message, which could be any of the rules in the rule set, depending on how many rules there are and how many partitions are processed. It's possible to create a system that would employ a static final rule, however the implementation of such a change would not appreciably improve security.

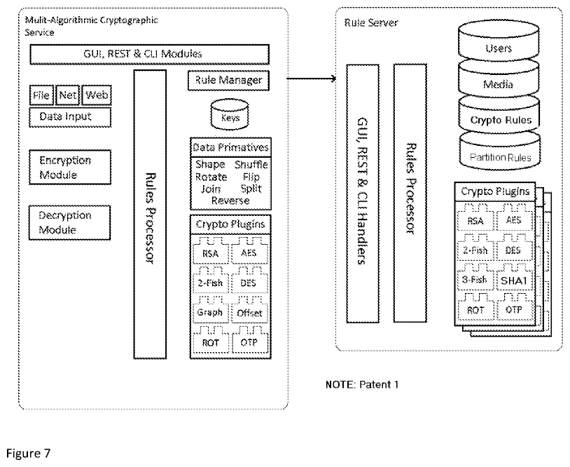

FIG. 7 illustrates an exemplary block diagram denoting communication between a multi-algorithmic cryptographic service and a rule server associated therewith, both the multi-algorithmic cryptographic service and the rule server having multiple partitioning algorithms, cryptographic keys, and key-based algorithms to encrypt and to decrypt data in discrete parts providing message secrecy, integrity and authenticity for communications and storage in accordance with an embodiment of the present invention. In the present embodiment, a cryptographic system 700 includes a multi-algorithmic cryptographic service 702 in electronic communication with a rule server 704. Both the cryptographic service 702 and rule server 704 may be installed on and/or with a computer-based system and/or network requiring at least intermittent usage of one or more pieces of computer hardware, e.g., processor(s) and/or non-transitory memory, for required functionality and/or operation.

Generally, the multi-algorithmic cryptography service 702 refers to software that applies a set of rules, consisting of multiple partitioning algorithms, cryptographic keys, and key-based algorithms, to encrypt and decrypt data in discrete parts providing message secrecy, integrity and authenticity for communications and storage. In an embodiment, the multi-algorithmic cryptography service 702 may include a set of rules with each rule containing a unique combination of algorithms, cryptographic keys, data sizes, initial offsets, and counters that are used to encrypt and decrypt data. By way of example and not limitation, rules may: be arbitrarily complex and may reference other rules; use any existing cryptographic methods; and make modifications to the rule set including destruction of rules and self-modification. In one or more embodiments, a rule set may be acquired from a rule server or otherwise be manually generated; and, a set of rules may be arbitrarily large where, during typical operation, only a subset of the set of rules may be selected and/or implemented for a particular operation.

In an embodiment, the multi-algorithmic cryptography service 702 and/or rule server 704 can individually and/or in unison encrypt and/or decrypt any digital data, including local files and network streams, using a set of rules. The rules used during encryption must be reversible for decryption to be possible. When data is received by the multi-algorithmic cryptography service, e.g., via a data input 710, a subset of rules may be acquired, e.g., from a rule manager 718 in communication with the rule server 704 storing, at least, rules 752, where a first or initial rule from rules 752 may be applied or implemented. Each rule may define a block size used where the block may be acquired from data, e.g., as provided by the data input 710. Should an initial offset operation be implemented as a part of implementation of the first rule, the first rule may skip forward by a data sequence or position commensurate with the offset operation in the acquired data when acquiring the first block. In an embodiment, each rule in the rule set may be applied to the data until all data is consumed, including any data initially skipped by the offset operation. Moreover, in one or more embodiments, rules may modify other rules including themselves based on counters, the amount of data processed, or other criteria and/or triggering conditions.

Returning to the cryptographic system 700 shown in FIG. 7, the cryptographic system 700 may be implemented and/or integrated with any one or more of the modules and/or systems shown and discussed in connection with FIGS. 1-6 to, for example, perform and/or otherwise at least assist with the encryption and/or decryption of raw data resulting in the transformation of raw data into encrypted data and/or vice-versa for any one or more end-used applications or configurations that may be desired by a human and/or computer-based end user. In an embodiment, the multi-algorithmic cryptographic service 702 may include a GUI, REST and/or CLI modules embedded therewith for electronic communication with any one or more selected from a group including: the data input 710 (e.g., inclusive of files, local intra-net, or global Internet, e.g., web, based sources); an encryption module 712, a decryption module 714, and/or a OTP generator 716. Those skilled in the art will appreciate that the modules and/or generators provided herein are by example and not limiting. Other suitable modules and/or generators may exist suitable for the purposes of data transformation from raw data to encrypted data and vice-versa. A rules processor 728, also embedded within and/or otherwise associated with the multi-algorithmic cryptographic service, may electronically communicate with any one or more of the data input 710, the encryption module 712, and/or the decryption module 714 to further process data acquired from, e.g., the data input 710 as may be dictated by, for example (and not limitation thereto) the rule manager 718. In one or more embodiments, various media 720, pads 722, and/or keys 724 may be associated with the rule manager 718 and/or otherwise be embedded or included in the multi-algorithmic cryptographic service 702 for access by the rule manager 718 to further process and/or transform data pursuant to one or more rules 752 as accessed from the rule server 704.

By way of example and not limitation, such implementation of rules from the rule server 704 as conducted and/or otherwise performed by the multi-algorithmic cryptographic service 702 includes implementation of one or more data primitive operations 726 inclusive of (by way of example and not limitation): shaping, shuffling, rotation, flipping, joining, splitting, and/or reversal. Moreover, in combination with or in lieu of, data, subject to rules promulgated by the rule manager 718 may be subject to further and/or alternative transformation by various specific cryptographic plugins, inclusive of (by way of example and not limitation): a RSA plug-in 730, a AES plug-in 732, a 2-Fish plug-in 734, a DES plug-in 736, a graph plug-in 738, an offset plug-in 740, a ROT plug-in 742, and a OTP plug-in 744.

Each cryptographic plug-in can have multiple parameters that a rule can use to create unique operations. Further, rules can edit their own parameters as well as the parameters of other rules. Rules can also destruct themselves as well as other rules and can destroy keys and key-based algorithmic plug-ins that have been used during operations. Destruction or removal of these items from the host system provides additional security in the event of an attacker gaining remote or physical access to the host. Those skilled in the art may appreciate that the plug-ins, identified by their typical industry acronyms, may function substantially as per industry paradigm and/or include any suitable variant thereof.

Referring to the rule server 704, the rule manager 718 of the multi-algorithmic cryptographic service 702 may electronically communicate with GUI, REST and/or CLI handlers 746 and/or a rules processor 748, any one or more that may access and/or electronically communicate with human and/or computer-based users 750, the rules 752, media 754, and/or keys 756. And, in one or more embodiments, the rule server 704 may store any one or more various specific cryptographic plugins 758, similar to those included in the multi-algorithmic cryptographic service 702, inclusive of (by way of example and not limitation): a RSA plug-in 760, a AES plug-in 762, a 2-Fish plug-in 764, a DES plug-in 766, a graph plug-in 768, an offset plug-in 770, a ROT plug-in 772, and a OTP plug-in 774. Any one or more of the cryptographic plugins 758 may be accessed by the rule server 704 and/or communicated to the multi-algorithmic cryptographic service 702 to at least assist with data transformation.FIG. 8 illustrates an exemplary flow diagram of a method for applying a configurable caeser cipher in accordance with an embodiment of the present invention. In the present embodiment, discussions of caeser ciphers may stem from a general foundation in cryptographic theory, which, being one of the earliest known forms of cryptography. A simple caeser cipher rotates all characters, as if the alphabet were on a long continuous loop which can be shifted. A shift of one space would change A to B, B to C, etc. A shift of 10 spaces would shift A to K, B to L, etc. Letters at the end of the alphabet would become letters at the beginning of the alphabet, such that shifting Z by one space would result in A.

In the context of a caeser cipher system 800 shown in FIG. 8, the cryptography handler 106 may acquire, implement, and/or otherwise functionally integrate a caeser cipher based cryptographic module which may be used in whole or part during encryption and subsequent decryption operations. Regarding usage of a caeser cipher cryptographic module and/or one or more sets of caeser cipher rules, data transformation process 802, in an embodiment, may involve receipt of a raw data message 804, e.g., “It was the best of times. It was the worst of times.” The raw data message 804 may be passed, by the data transformation process 802, to a rule set 806, which may implement one or more data transformation rules, e.g. 1. 4 characters, ROT, 13; 2. 4 characters, ROT 44, and so on and so forth to encrypt the raw data message 804 to create or otherwise produce partially encrypted data 808, which may undergo a further transformation operation 810, e.g., an offset operation, to create fully encrypted data 812.

Data transformation process 814, in an embodiment, may involve transforming fully encrypted data 812 back to its original un-encoded form as raw data message 804, e.g., “It was the best of times. It was the worst of times.” by, for example (but not limitation thereto) at least substantially reversing the application and/or functionality of each of the encryption operations 806-810 via corresponding decryption operations 816-824. More particularly, fully encrypted data 816, which may up-loaded to a virtual and/or Internet and/or “cloud” based source and/or server, may pass to a reverse offset operation 818 to produce partially decrypted data 820. A rule set 822, which may be identical to rule set 806, may be applied to the partially decrypted data 820 to reverse the earlier encryption by the rule set 806 to produce fully decrypted message, e.g., “It was the best of times. It was the worst of times.” Those skilled in the art will appreciate that the decryption operations 816-822 at least substantially resemble and/or mimic the encryption operations 806-810; however, other suitable variations in configuration and/or data flow may exist without departing from the scope and spirit of data transformation back to producing fully decrypted message 824, e.g., any one or more of decryption operations may be implemented and/or practiced in an order or configuration other than that shown for data transformation process 814 but still produce the fully decrypted message 824.

FIG. 9 illustrates exemplary data primitive operations for rules, the rules including various algorithms, keys, pads and media, the data primitive operations including sizing, shaping, shuffling, rotating, flipping, splitting, joining and reversing the data in accordance with an embodiment of the present invention. In the present embodiment, data, as generally understood and as referred to herein, includes a set of values of subjects with respect to qualitative or quantitative variables. Data and information or knowledge are may be used and/or referred to interchangeably; however, data may become information when it is viewed in context or in post-analysis. Data primitive operations 900, generally, may refer to basic computations performed by an algorithm. Examples are evaluating an expression, assigning a value to a variable, indexing into an array, calling a method, returning from a method, etc. They are easily identifiable in pseudocode and largely independent from the programming language. [Source: https://www.cpp.edu/˜ftang/courses/CS240/lectures/analysis.htm; Jun. 22, 2019].

The partitioning and cryptographic rules can be split or combined into a single rule. As shown in FIG. 9, there is a local store of 10 rules. Each rule acquires 4 characters of data (4 bytes in most systems) and then performs a simple rotation of that character (space is included in the character set for this example). During communication a subset of rules is chosen and then applied in order to the data until there is no more data to transform. At this point the assembled encrypted partitions are stored or transmitted. As shown in FIG. 9, during decryption, the same rules are again applied only in reverse. In the example shown, decryption could start at the beginning of the assembled encrypted partitions or at the end.

Further, FIG. 9 is provided to illustrates the vast number of operations which are why they are a good factor in pad creation and cryptography.

Data primitive operations 900, in an embodiment, may manipulate data primitives and/or primitive data types, which may refer to, generally, either of the following: (1) a “basic type” is a data type provided by a programming language as a basic building block; many computing languages may allow more complicated composite types to be recursively constructed starting from basic types; (2) “a built-in” type is a data type for which the programming language provides built-in support.

In one or more embodiments, the data primitive operations 900 may manipulate such data primitives, primitive data types, and/or data, such as data 902, as so described, by, for example (but without limitation thereto) the following operations: a vertical halving operation 904, a horizontal halting operation 906, a quarter, shuffle, and rotate operation 908, a rotate, halve, apply specific pads to specific parts, and shuffle operation 910, and rotate, quarter, and shuffle operation 912.

Each data primitive operation 904-912 may function substantially as shown in FIG. 9 to manipulate the data 902. That is, vertical halving operation 904 may receive data 902 input there-into to vertically halve the data, quarter both vertical halves, and shuffle the data 902 horizontally. The horizontal halving operation 906 may receive data 902 input there-into to halve the data 902 horizontally and, for example (but without limitation thereto), apply a first key (e.g., “Key 1”) to a first part of the halved data (e.g., “Part 1”), and to apply a second key (e.g., “Key 2”) to a second part of the halved data (e.g., “Part 2”). The quarter, shuffle, and rotate operation 908 may receive data 902 input there-into to horizontally quarter the data 902 prior to shuffling the data 902 and rotating the data 902 180°. The rotate, halve, apply specific pads to specific parts, and shuffle operation 910 may receive data 902 input there-into to perform at least the following operations (in the order listed and/or in any other order): (1) rotate the data 902 by 90°; (2) halve the data 902 vertically; (3) apply a first pad, e.g., such as a one-time pad and/or a non-random pad, also referred to as “Pad 1” to a first part defined by the vertical halving, e.g., referred to as “Part 1” and apply a second pad, e.g., such as a one-time pad and/or a non-random pad, also referred to as “Pad 2” to a second part defined by the vertical halving, e.g., referred to as “Part 2”; and, (4) shuffle the data 902. The rotate, quarter, and shuffle operation 912 may receive data 902 input there-into to perform at least the following operations (in the order listed and/or in any other order): (1) rotate the data 902 by 90°; (2) quarter the data 902 vertically; and, (3) shuffle the data 902 vertically. Those skilled in the art will appreciate that the data primitive operations 904-912 are provided as an example only and that an innumerable number of other data primitive operations 900 may exist able to manipulate and/or transform the data 902 in an innumerable number of ways and/or methods, etc.

In one or more embodiments, the data 902 may be shaped as “Media 1” defined as a 6×6 block 914 of data and/or may be shaped as “Media 2” also defined as a 6×6 block 916 of data. The data 902 may be subject to: vertical data combination operations that include any one or more of operations 920-930; horizontal data combination operations 932-942; shuffle operations 944-954, and quarter then shuffle operations 956-962. Those skilled in the art that such operations 920-962 are provided as an example only and are thus non-limiting and that an innumerable number of other data primitive operations 900 may exist able to manipulate and/or transform the data 902 in an innumerable number of ways and/or methods, etc.

As shown in FIG. 9, in one or more embodiments, the data 902 may be transformed into a two dimensional shape, such as a 3×3 square 973, and rotated around a cell, such as the middle cell 973. It is well known in the art that a grid, including grids that are not of equal length and width, can be rotated around any cell and produce dissimilar results.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Such computers referenced and/or described in this disclosure may be any kind of computer, either general purpose, or some specific purpose computer such as, but not limited to, a workstation, a mainframe, GPU, ASIC, etc. The programs may be written in C, or Java, Brew or any other suitable programming language. The programs may be resident on a storage medium, e.g., magnetic or optical, e.g., without limitation, the computer hard drive, a removable disk or media such as, without limitation, a memory stick or SD media, or other removable medium. The programs may also be run over a network, for example, without limitation, with a server or other machine sending signals to the local machine, which allows the local machine to carry out the operations described herein.

Integration of the Disclosed Embodiments with an Example Client/Server Systems

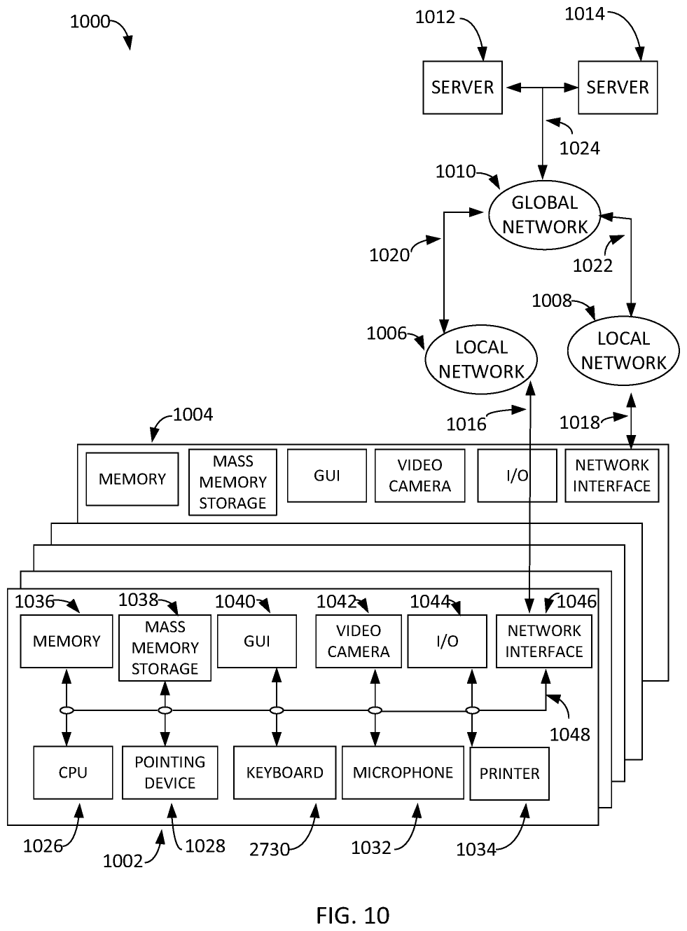

FIG. 10 illustrates an exemplary block diagram depicting an example client/server system that may be used by an example web-enabled/networked embodiment of the present invention. FIG. 10 further illustrates that it is reasonable to expect that the current invention could be deployed at multiple locations including 706, 708, 712, 714, 716, 718, 744 and 746. At the computer level, the embodiments could be included in a network or disk driver or in multiple applications, such as email, chat and web browsing. Modern cryptography continues to increase in both complexity and computational costs. The embodiments could extend the usable life span of older and less costly cryptographic algorithms due to the additional factors that have been engineered.

A communication system 1000 includes a multiplicity of clients with a sampling of clients denoted as a client 1002 and a client 1004, a multiplicity of local networks with a sampling of networks denoted as a local network 1006 and a local network 1008, a global network 1010 and a multiplicity of servers with a sampling of servers denoted as a server 1012 and a server 1014.

Client 1002 may communicate bi-directionally with local network 1006 via a communication channel 1016. Client 1004 may communicate bi-directionally with local network 1008 via a communication channel 1018. Local network 1006 may communicate bi-directionally with global network 1010 via a communication channel 1020. Local network 1008 may communicate bi-directionally with global network 1010 via a communication channel 1022. Global network 1010 may communicate bi-directionally with server 1012 and server 1014 via a communication channel 1024. Server 1012 and server 1014 may communicate bi-directionally with each other via communication channel 1024. Furthermore, clients 1002, 1004, local networks 1006, 1008, global network 1010 and servers 1012, 1014 may each communicate bi-directionally with each other.

In one embodiment, global network 1010 may operate as the Internet. It will be understood by those skilled in the art that communication system 1000 may take many different forms. Non-limiting examples of forms for communication system 1000 include local area networks (LANs), wide area networks (WANs), wired telephone networks, wireless networks, or any other network supporting data communication between respective entities.

Clients 1002 and 1004 may take many different forms. Non-limiting examples of clients 1002 and 1004 include personal computers, personal digital assistants (PDAs), cellular phones and smartphones.

Client 1002 includes a CPU 1026, a pointing device 1028, a keyboard 1030, a microphone 1032, a printer 1034, a memory 1036, a mass memory storage 1038, a GUI 1040, a video camera 1042, an input/output interface 1044 and a network interface 1046.

CPU 1026, pointing device 1028, keyboard 1030, microphone 1032, printer 1034, memory 1036, mass memory storage 1038, GUI 1040, video camera 1042, input/output interface 1044 and network interface 1046 may communicate in a unidirectional manner or a bi-directional manner with each other via a communication channel 1048. Communication channel 1048 may be configured as a single communication channel or a multiplicity of communication channels.

CPU 1026 may be comprised of a single processor or multiple processors. CPU 1026 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 1036 is used typically to transfer data and instructions to CPU 1026 in a bi-directional manner. Memory 1036, as discussed previously, may include any suitable computer-readable media, intended for data storage, such as those described above excluding any wired or wireless transmissions unless specifically noted. Mass memory storage 1038 may also be coupled bi-directionally to CPU 1026 and provides additional data storage capacity and may include any of the computer-readable media described above. Mass memory storage 1038 may be used to store programs, data and the like and is typically a secondary storage medium such as a hard disk. It will be appreciated that the information retained within mass memory storage 1038, may, in appropriate cases, be incorporated in standard fashion as part of memory 1036 as virtual memory.

CPU 1026 may be coupled to GUI 1040. GUI 1040 enables a user to view the operation of computer operating system and software. CPU 1026 may be coupled to pointing device 1027. Non-limiting examples of pointing device 1027 include computer mouse, trackball and touchpad. Pointing device 1027 enables a user with the capability to maneuver a computer cursor about the viewing area of GUI 1040 and select areas or features in the viewing area of GUI 1040. CPU 1026 may be coupled to keyboard 1030. Keyboard 1030 enables a user with the capability to input alphanumeric textual information to CPU 1026. CPU 1026 may be coupled to microphone 1032. Microphone 1032 enables audio produced by a user to be recorded, processed and communicated by CPU 1026. CPU 1026 may be connected to printer 1034. Printer 1034 enables a user with the capability to print information to a sheet of paper. CPU 1026 may be connected to video camera 1042. Video camera 1042 enables video produced or captured by user to be recorded, processed and communicated by CPU 1026.

CPU 1026 may also be coupled to input/output interface 1044 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1026 optionally may be coupled to network interface 1046 which enables communication with an external device such as a database or a computer or telecommunications or internet network using an external connection shown generally as communication channel 1016, which may be implemented as a hardwired or wireless communications link using suitable conventional technologies. With such a connection, CPU 1026 might receive information from the network, or might output information to a network in the course of performing the method steps described in the teachings of the present invention.

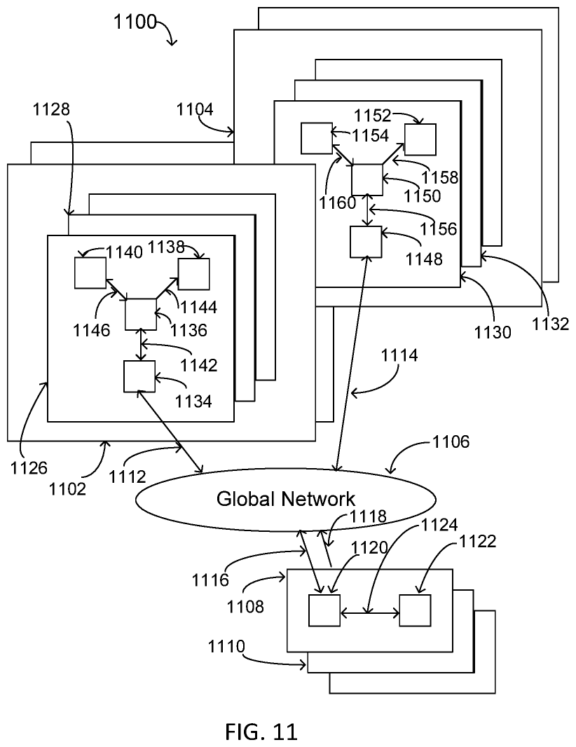

FIG. 11 illustrates an exemplary block diagram depicting an example client/server communication system that may be used for a cryptographic security system using data partitioning and configurable key-based encryption and/or decryption in accordance with an embodiment of the present invention. A communication system 1100 includes a multiplicity of networked regions with a sampling of regions denoted as a network region 1102 and a network region 1104, a global network 1106 and a multiplicity of servers with a sampling of servers denoted as a server device 1108 and a server device 1110.

Network region 1102 and network region 1104 may operate to represent a network contained within a geographical area or region. Non-limiting examples of representations for the geographical areas for the networked regions may include postal zip codes, telephone area codes, states, counties, cities and countries. Elements within network region 1102 and 1104 may operate to communicate with external elements within other networked regions or within elements contained within the same network region.

In some implementations, global network 1106 may operate as the Internet. It will be understood by those skilled in the art that communication system 1100 may take many different forms. Non-limiting examples of forms for communication system 1100 include local area networks (LANs), wide area networks (WANs), wired telephone networks, cellular telephone networks or any other network supporting data communication between respective entities via hardwired or wireless communication networks. Global network 1106 may operate to transfer information between the various networked elements.

Server device 1108 and server device 1110 may operate to execute software instructions, store information, support database operations and communicate with other networked elements. Non-limiting examples of software and scripting languages which may be executed on server device 1108 and server device 1110 include C, C++, C# and Java.

Network region 1102 may operate to communicate bi-directionally with global network 1106 via a communication channel 1112. Network region 1104 may operate to communicate bi-directionally with global network 1106 via a communication channel 1114. Server device 1108 may operate to communicate bi-directionally with global network 1106 via a communication channel 1116. Server device 1110 may operate to communicate bi-directionally with global network 1106 via a communication channel 1118. Network region 1102 and 1104, global network 1106 and server devices 1108 and 1110 may operate to communicate with each other and with every other networked device located within communication system 1100.

Server device 1108 includes a networking device 1120 and a server 1122. Networking device 1120 may operate to communicate bi-directionally with global network 1106 via communication channel 1116 and with server 1122 via a communication channel 1124. Server 1122 may operate to execute software instructions and store information.

Network region 1102 includes a multiplicity of clients with a sampling denoted as a client 1126 and a client 1128. Client 1126 includes a networking device 1134, a processor 1136, a GUI 1138 and an interface device 1140. Non-limiting examples of devices for GUI 1138 include monitors, televisions, cellular telephones, smartphones and PDAs (Personal Digital Assistants). Non-limiting examples of interface device 1140 include pointing device, mouse, trackball, scanner and printer. Networking device 1134 may communicate bi-directionally with global network 1106 via communication channel 1112 and with processor 1136 via a communication channel 1142. GUI 1138 may receive information from processor 1136 via a communication channel 1144 for presentation to a user for viewing. Interface device 1140 may operate to send control information to processor 1136 and to receive information from processor 1136 via a communication channel 1146. Network region 1104 includes a multiplicity of clients with a sampling denoted as a client 1130 and a client 1132. Client 1130 includes a networking device 1148, a processor 1150, a GUI 1152 and an interface device 1154. Non-limiting examples of devices for GUI 1138 include monitors, televisions, cellular telephones, smartphones and PDAs (Personal Digital Assistants). Non-limiting examples of interface device 1140 include pointing devices, mousse, trackballs, scanners and printers. Networking device 1148 may communicate bi-directionally with global network 1106 via communication channel 1114 and with processor 1150 via a communication channel 1156. GUI 1152 may receive information from processor 1150 via a communication channel 1158 for presentation to a user for viewing. Interface device 1154 may operate to send control information to processor 1150 and to receive information from processor 1150 via a communication channel 1160.

For example, without limitation, consider the case where a user interfacing with client 1126 may want to execute a networked application. A user may enter the IP (Internet Protocol) address for the networked application using interface device 1140. The IP address information may be communicated to processor 1136 via communication channel 1146. Processor 1136 may then communicate the IP address information to networking device 1134 via communication channel 1142. Networking device 1134 may then communicate the IP address information to global network 1106 via communication channel 1112. Global network 1106 may then communicate the IP address information to networking device 1120 of server device 1108 via communication channel 1116. Networking device 1120 may then communicate the IP address information to server 1122 via communication channel 1124. Server 1122 may receive the IP address information and after processing the IP address information may communicate return information to networking device 1120 via communication channel 1124. Networking device 1120 may communicate the return information to global network 1106 via communication channel 1116. Global network 1106 may communicate the return information to networking device 1134 via communication channel 1112. Networking device 1134 may communicate the return information to processor 1136 via communication channel 1142. Communication channel 1146 may communicate the return information to GUI 1138 via communication channel 1144. User may then view the return information on GUI 1138.

### Practice of Method Steps or Components Outside of the US

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, without limitation, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6)/(f) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6) pre-AIA or 35 USC § 112 (f) post AIA. In some embodiments, the methods and/or system components which may be located and/or performed remotely include, without limitation: any one or more of the cryptographic system 100 shown in FIG. 1 and/or any one or more of the systems and/or modules shown and discussed in connection FIGS. 2-5

It is noted that according to USA law, all claims must be set forth as a coherent, cooperating set of limitations that work in functional combination to achieve a useful result as a whole. Accordingly, for any claim having functional limitations interpreted under 35 USC § 112 (6)/(f) where the embodiment in question is implemented as a client-server system with a remote server located outside of the USA, each such recited function is intended to mean the function of combining, in a logical manner, the information of that claim limitation with at least one other limitation of the claim. For example, without limitation, in client-server systems where certain information claimed under 35 USC § 112 (6)/(f) is/(are) dependent on one or more remote servers located outside the USA, it is intended that each such recited function under 35 USC § 112 (6)/(f) is to be interpreted as the function of the local system receiving the remotely generated information required by a locally implemented claim limitation, wherein the structures and or steps which enable, and breathe life into the expression of such functions claimed under 35 USC § 112 (6)/(f) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present patent application, and “35 USC § 112 (6)/(f)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a cryptographic security system using data partitioning and configurable key-based encryption and/or decryption permitting for data from a file or stream to broken into multiple parts or partitions where a different key and key-based algorithm may be applied to each partition during encryption and/or decryption according to the present invention will be apparent to those skilled in the art. Various aspects of the invention have been described above by way of illustration, and the specific embodiments disclosed are not intended to limit the invention to the particular forms disclosed. The particular implementation of a cryptographic security system using data partitioning and configurable key-based encryption and/or decryption permitting for data from a file or stream to broken into multiple parts or partitions where a different key and key-based algorithm may be applied to each partition during encryption and/or decryption may vary depending upon the particular context or application. By way of example, and not limitation, the a cryptographic security system using data partitioning and configurable key-based encryption and/or decryption permitting for data from a file or stream to broken into multiple parts or partitions where a different key and key-based algorithm may be applied to each partition during encryption and/or decryption described in the foregoing were principally directed to data encryption and/or decryption implementations; however, similar techniques may instead be applied to other areas and/or fields of computer science and/or data management, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification. While embodiments described herein illustrate data encryption and/or decryption, the operations described here may also be used to provide authentication, authorization, non-repudiation and tamper resistance using known methods. The disclosed invention can be used to provide improved levels of security when implementing the listed items.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A cryptographic method, comprising the steps of:
a. receiving data;
b. retrieving a set of partitioning algorithms and distinct, cryptographic key and key-based cryptographic algorithm rule pairs;
c. partitioning the data using the set of partitioning algorithms to produce data partitions;
d. performing an operation on each of the data partitions using one of the distinct, cryptographic key and key-based cryptographic algorithm rule pairs to generate resulting partitions; and
e. assembling the resulting partitions.

2. The method of claim 1, in which the producing data partitions further comprise the steps of producing raw data partitions and the generating the resulting partitions comprise generating resulting encrypted partitions.

3. The method of claim 1, wherein the producing the data partitions further comprises the step of producing encrypted data partitions and the generating the resulting partitions further comprise the step of generating resulting raw data partitions.

4. The method of claim 1, further comprising the steps of receiving a list of partitioning and cryptographic algorithms and accepting identifiers, keys, offsets and data sources to use as a configuration to control encryption and decryption operations.

5. The method of claim 1 further comprising the steps of configuring a second system using configuration information and destroying the configuration information on the system after being used for encryption in which decryption can only be performed by either retrieving the configuration from the second system or sending the encrypted data to the second system.

6. The method of claim 1 further comprising the steps of applying a reuse process during encryption and decryption to allow the number of partitions to exceed the number of key and algorithm pairs.

7. The method of claim 1 further comprises the step of determining, by the partition handler, an offset, in which the step of receiving the data further comprises the step receiving, by a data handler, data and an identifier, the identifier determining an partitioning operations and cryptographic operations to perform on the data, in which the step of partitioning the data further comprises the steps of retrieving, by a partition handler, a set of partitioning algorithms according to the identifier and partitioning the data using the offset and the set of partitioning algorithms to produce data partitions, the partition handler further produces raw data partitions when the data comprises raw data and produces encrypted data partitions when the data comprises encrypted data, in which the step of performing an operation on each of the data partitions further comprises the steps of retrieving, by an cryptography handler, distinct, cryptographic key and key-based cryptographic algorithm rule pairs according to the identifier, the cryptography handler, and generating in a single pass resulting encrypted partitions from raw data partitions received from the partition handler and resulting raw data partitions from encrypted data partitions received from the partition handler using the distinct, cryptographic key and key-based cryptographic algorithm rule pairs, and in which the step of assembling the resulting partitions further comprises the steps of assembling, by the cryptography handler, the encrypted partitions to generate an encrypted data message and assembling the resulting raw data partitions to generate a raw data message.

8. A cryptographic system, comprising:
a. means for receiving data;
b. means for retrieving a set of partitioning algorithms and distinct, cryptographic key and key-based cryptographic algorithm rule pairs;
c. means for partitioning the data using the set of partitioning algorithms to produce data partitions;
d. means for performing an operation on each of the data partitions using one of the distinct, cryptographic key and key-based cryptographic algorithm rule pairs to generate resulting partitions; and
e. means for assembling the resulting partitions.

9. The method of claim 8, wherein the means for producing data partitions comprise means for producing raw data partitions and the means for generating the resulting partitions comprise means for generating resulting encrypted partitions.

10. The method of claim 8, wherein the means for producing the data partitions comprises means for producing encrypted data partitions and the means for generating the resulting partitions comprise means for generating resulting raw data partitions.

11. The method of claim 8, further comprising means for receiving a list of partitioning and cryptographic algorithms and means for accepting identifiers, keys, offsets and data sources to use as a configuration to control encryption and decryption operations.

12. The method of claim 8 further comprising means for configuring a second system using configuration information and means for destroying the configuration information on the system after being used for encryption in which decryption can only be performed by either the means for retrieving the configuration from the second system or by means for sending the encrypted data to the second system.

13. The method of claim 8 further comprising means for applying a reuse process during encryption and decryption to allow the number of partitions to exceed the number of key and algorithm pairs.

14. The method of claim 8 further comprising means for applying an offset during encryption after assembling the resulting partitions and means for reversing the offset during decryption before applying the partitioning algorithm.

15. A non-transitory computer-readable storage medium with an executable program stored thereon, wherein the program instructs one or more processors to perform the following steps:
a. receiving data;
b. retrieving a set of partitioning algorithms and distinct, cryptographic key and key-based cryptographic algorithm rule pairs;
c. partitioning the data using the set of partitioning algorithms to produce data partitions;
d. performing an operation on each of the data partitions using one of the distinct, cryptographic key and key-based cryptographic algorithm rule pairs to generate resulting partitions; and
e. assembling the resulting partitions.

16. The program instructing the one or more processors as recited in claim 15, in which the producing data partitions further comprise producing raw data partitions and the generating the resulting partitions comprise generating resulting encrypted partitions.

17. The program instructing the one or more processors as recited in claim 15, in which the producing the data partitions further comprises the step of producing encrypted data partitions and the generating the resulting partitions further comprise the step of generating resulting raw data partitions.

18. The program instructing the one or more processors as recited in claim 15, further comprising the steps of receiving a list of partitioning and cryptographic algorithms and accepting identifiers, keys, offsets and data sources to use as a configuration to control encryption and decryption operations.

19. The program instructing the one or more processors as recited in claim 15 further comprising the steps of configuring a second system using configuration information and destroying the configuration information on the system after being used for encryption in which decryption can only be performed by either retrieving the configuration from the second system or sending the encrypted data to the second system.

20. The program instructing the one or more processors as recited in claim 15 further comprising the steps of applying an offset during encryption after assembling the resulting partitions and reversing the offset during decryption before applying the partitioning algorithm.
